(19) United States
(12) Patent Application Publication
(10) Pub. No.: US 2026/0189477 A1
(43) Pub. Date: Jul. 2, 2026

(54) DEVICE-CENTRIC NETWORK ROUTER CONFIGURATION

(71) Applicant: PERFTECH, INC., San Antonio, TX (US)

(72) Inventors: Peter Wayne Baron, Wimauma, FL (US); Lewis T. Donzis, San Antonio, TX (US); Richard Y. Murata, Shertz, TX (US)

(21) Appl. No.: 19/005,724

(22) Filed: Dec. 30, 2024

(51) Int. Cl. H04L 41/22; H04L 67/00

(52) U.S. Cl. CPC H04L 41/22; H04L 67/34

(57) ABSTRACT

An example operation may include one or more of storing router configuration settings of a network router, displaying a graphical user interface (GUI) that comprises a plurality of graphical elements corresponding to a plurality of network devices controlled by a network router, detecting a selection of a graphical element corresponding to a network device from among the plurality of graphical elements corresponding to the plurality of network devices based on a user input via the GUI, displaying router settings of the network device corresponding to the graphical element in response to the selection, receiving a configuration of the router settings of the network device based on an additional user input via the GUI, and applying the configuration of the router settings of the network device to the router configuration settings of the network router.

### BACKGROUND

One of the benefits of a network router is that it allows for connectivity between different devices and networks. For example, multiple devices can be connected to the Internet and to each other through a single network router. In a home environment, a network router can connect multiple devices such as laptops, smartphones, tablets, televisions, smart wearables, vehicles, and the like, to the Internet and allow them to communicate with each other. In a business environment, network routers can be used to connect multiple computers and servers to the Internet and to each other, allowing for seamless communication between employees and users outside the business.

A network router is typically configured using IP addresses, where the instructions for controlling network traffic must be learned and then edited. Within the network router, IP address tables are used for address reservation, port forwarding, and for enabling Internet protocols, such as UPnP. Configuration can be complicated, so router software is often provided to simplify configuration for the most common tasks. Furthermore, users often go through extensive training and receive certifications before fully understanding how a router can be configured. Another problem with router configurations is that the configuration is performed from the perspective of the router where you must provide the information for the device (e.g., an IP address).

### SUMMARY

One example embodiment provides an apparatus that includes one or more of a memory configured to store router configuration settings of a network router, and a processor configured to display a graphical user interface (GUI) that comprises a plurality of graphical elements corresponding to a plurality of network devices controlled by a network router, detect a selection of a graphical element corresponding to a network device from among the plurality of graphical elements corresponding to the plurality of network devices based on a user input via the GUI, display router settings of the network device corresponding to the graphical element in response to the selection, receive a configuration of the router settings of the network device based on an additional user input via the GUI, and apply the configuration of the router settings of the network device to the router configuration settings of the network router.

Another example embodiment provides a method that includes one or more of storing router configuration settings of a network router, displaying a graphical user interface (GUI) that comprises a plurality of graphical elements corresponding to a plurality of network devices controlled by a network router, detecting a selection of a graphical element corresponding to a network device from among the plurality of graphical elements corresponding to the plurality of network devices based on a user input via the GUI, displaying router settings of the network device corresponding to the graphical element in response to the selection, receiving a configuration of the router settings of the network device based on an additional user input via the GUI, and applying the configuration of the router settings of the network device to the router configuration settings of the network router.

A further example embodiment provides a computer-readable medium comprising instructions, that when read by a processor, cause the processor to perform one or more of storing router configuration settings of a network router, displaying a graphical user interface (GUI) that comprises a plurality of graphical elements corresponding to a plurality of network devices controlled by a network router, detecting a selection of a graphical element corresponding to a network device from among the plurality of graphical elements corresponding to the plurality of network devices based on a user input via the GUI, displaying router settings of the network device corresponding to the graphical element in response to the selection, receiving a configuration of the router settings of the network device based on an additional user input via the GUI, and applying the configuration of the router settings of the network device to the router configuration settings of the network router.

### BRIEF DESCRIPTION OF THE DRAWINGS

FIG. 1A is a diagram illustrating a network computing environment including a plurality of routing apparatuses according to example embodiments.

FIG. 1B is a diagram illustrating components that may be included in a routing apparatus according to example embodiments.

FIG. 2 is a diagram illustrating a process of a network router outputting a graphical user interface to a remote device over a computer network according to example embodiments.

FIGS. 3A-3E are diagrams illustrating a process of configuring device-centric router settings through a GUI according to example embodiments.

FIGS. 4A-4G are diagrams illustrating a process of generating and output notifications from a network router to a remote device according to example embodiments.

FIGS. 5A-5F are diagrams illustrating a process of identifying network devices through color selection according to example embodiments.

FIGS. 6A-6G are diagrams illustrating a process of one or more network devices inheriting network controls according to example embodiments.

FIG. 7 is a diagram illustrating a method of configuring device-centric router settings through a GUI according to example embodiments.

FIG. 8 is a diagram illustrating a method of using colors for rapid identification of a user on a network according to example embodiments.

FIG. 9 is a diagram illustrating a process of router configuration through inheritance grouping according to example embodiments.

FIG. 10 is a diagram illustrating a method of generating and transmitting a notification from a network router to a remote device according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a routing apparatus (also referred to herein as a network router, router, etc.) The network router may be geared for gigabit Internet, and also designed to accommodate future generation speeds. For example, the network router may include multiple Ethernet ports that have a 1 Gbps Ethernet capacity or more. The network router may enable thousands of connected devices and may collect and store activity data of the connected devices. The network router may include a dual-channel memory and may support both Internet Protocol version four (IPv4) which uses a 32-bit address and Internet Protocol version six (IPv6) which uses a 128-bit address. The network router can support multiple separate local area networks (LANs) at the same time, may isolate a guest Wireless Fidelity (WiFi) network, and may support multiple virtual LANs (VLANs) with automatic internal mapping. The network router may assign each connected device an IP address. The network router may perform port forwarding by device name. The network router may also support multiple Internet connections for redundancy and load balancing.

The network router may include a built-in firewall, and may protect all devices from threat-ware, malware, phishing, ransomware, and viruses. The network router may be configured to pause Internet access to any device. Furthermore, the network router may be configured to temporarily quarantine a new device when it joins the network. The network router may perform content filtering, web search filtering, safe search, intrusion prevention, and the like. The network router may also perform automatic virtual private network (VPN) self-configuring, and the like.

According to various embodiments, the network router may include a software application installed therein which provides a user with the ability to remotely configure settings of the network router. In some embodiments, the network router may be accessed by a remote device such as a smart phone, a laptop, a desktop, or the like. Here, the remote device may download and install a mobile application that provides access to the software installed on the network router. As another example, the remote device may include a web browser/mobile browser which may be used to navigate to an address of the software application. Once a connection is established, the software on the network router can output a graphical user interface (GUI) with different commands, controls, mechanisms, options, etc. to configure settings within the router including network controls, notifications, routing parameters, and the like.

According to various embodiments, the GUI that is provided by the network router enables a remote device to perform a device centric network router configuration. For example, the GUI may allow the remote device to one or more of set Dynamic Host Configuration Protocol (DHCP) reservations, port forwarding settings, enabling/disabling universal plug-n-play (UPnP), set a category, set a country, set hostname filters, pause/resume Internet access, set VPN usage, enable/disable cross local area network (LAN) access, set preferred wide area network (WAN) access, configure notifications, schedule notifications, and the like, for a particular device using inputs to the GUI.

The network router may then automatically configure its internal settings for the particular device, for example, a routing table within the network router, based on the configurations by the remote device. Thus, a remote user with little to no understanding of networking configurations can easily configure routing paths, etc. through the application.

Typically, routers are configured using IP addresses, where the instructions for controlling network traffic must be learned and then edited. The IP address tables are used for address reservation, port forwarding, and for enabling Internet protocols, such as UPnP. Configuration can be complicated, so router software is often provided to simplify configuration for the most common tasks. However, the configuration is performed from the perspective of the router where a trained user must provide the information for the device (e.g., IP address). In contrast, in the example embodiments, the software enables ‘device-centric’ approach which flips the configuration so that configuration is done from the perspective of each individual device, rather than the router. This simplifies configuration because the changes made apply only to the device in focus while eliminating the complexity of combining and integrating routing table edits. Furthermore, a change made to open a port, such as UPnP, may be limited to only that one device, and not for the entire network, which can reduce vulnerability for malware and network attacks. This approach also applies to content filtering where filter configuration is often performed from the perspective of the router where the settings for the devices are coalesced in one file. Our approach allows the content filtering to be applied directly to the individual devices.

Furthermore, the network router is also capable of automatically detecting certain routing data of a network device and filling-in the routing table(s) with such data which further eliminates the need for a routing professional. For example, the network router may automatically detect an Internet Protocol (IP) address of a network device. Therefore, rather than a user needing to input data to the network router such as adding an entry to the routing table, the network router can automatically detect this information and display it on the GUI.

In some embodiments, the network router may display and a graphical user interface to facilitate the control of network traffic to a device, including DHCP reservations, UPnP settings, port forwarding settings, category settings, country settings, hostname filters, Internet access settings, VPN usage settings, cross LAN access settings, preferred WAN access settings, notification configurations, notification schedules, and the like, for a particular device using inputs to the GUI. The network router may display a list of graphically represented network devices whose network access is controlled by the network router. In some embodiments, the network router may display a graphical element, page, menu, etc., corresponding to a network device to incorporate the router settings that are directly attributable to the control of network traffic to that particular network device In some embodiments, the network router may display a limited set of router settings and options on a graphical user interface options that are applicable to the particular network device, while at the same time automatically detecting other router settings and options thereby easing the need of the user to perform such configurations. In some embodiments, the network router may facilitate one or more of an addition, a change, and a removal of applicable network router settings through the configuration display of the network device, and in response to a change to a router setting, electronically apply the settings to the router configuration.

According to various embodiments, the network router may also enable rapid identification of users and devices on the network through color selection. For example, the GUI provided by the network router may include a page with a color palette which can be used to assign a particular color to a user. Each user may be assigned a different color. Here, the color may be applied aesthetically applied to visualizations within the GUI including visualizations of network activity, network traffic, notifications, and the like. Thus, a user viewing network activity of a device can easily recognize which user is associated with that device based on the particular color shown in the visualization of the network activity.

For example, a color may be assigned to a user group which includes multiple devices assigned to that user. This group of devices will all be displayed in the same color corresponding to the user. That is, the color ‘follows’ the user named group throughout the user interface. When the user is shown in a chart or graph, the user's data is displayed in that user's color in the chart or graph. Because color usage is consistently tied to a named group, the color in a chart becomes immediately relatable back to the user associated with the group. The software may consistently use the color throughout the user interface including integrating the color into otherwise ‘normal’ user interface components. For example, the color may be applied to lists, pop up lists, notifications, and scheduled events when the user interface component uniquely applies to the named component. Furthermore, the color ‘flows down’, or is inherited by child components. In a network router implementation, a network device that is assigned to a user or named group ‘inherits’ the parent's user or group color. Thus, when that device is graphed or appears in a user interface component or list, it includes the user or groups color too.

The GUI of the network router may also use colors for groups as well as users. In essence users are a type of group since a user represents a group of one or more devices that are assigned to a person. Groups (e.g., work, family room, gaming, cell phones, TVs, etc.) are more generic and can be used however a user might want to logically group their devices. For example, a user can use groups for devices that aren't affiliated with a user, such as “Audio/Visual”, for A/V devices around the home or business, or for devices that are affiliated with users but fall under a logical grouping that you might like to control such as “Gaming”, “TVs”, “Cell phones”. The groups may also contain one or more users. For example, a group named “Kids” could include multiple users for home users. As another example, a group may include “Marketing” for a business user. The GUI enables devices to assign one or more users to the groups. If a device belongs to a user AND a group, the GUI may use a hierarchy (e.g., the user's color instead of the group's color, etc.” when displaying a device of the user. A device that is only assigned to a group is shown with the group's color. Both users and groups pull from the same color palette.

In some embodiments, the router may assign a color as an identifiable attribute to a network user or user defined grouping on a graphical user interface. In some embodiments, the router may display a fixed, distinctive color palette for the selection of a single color, and in response to a selection, apply the color selection to a network user or a user defined group. In some embodiments, the router may display the selected color on the graphical user interface components that are directly attributable to the network user or user defined grouping. In some embodiments, the network router may display the selected color in network traffic charts, graphs, and visualizations in which the visualization of the network router traffic display includes traffic of the network user or user defined grouping.

In some embodiments, the network router may display light and dark variations of the selected color in network traffic charts, graphs, and visualizations in which the visualization of the network router traffic represents multiple entities belonging to the same network user or user defined grouping. In some embodiments, the network router may display the selected color in network calendars, alarms and notifications in which the visualization of calendar, alarms, or notifications includes events of the network user or user defined grouping. In some embodiments, the router may display a list of graphically represented network devices for association to a network user or user defined grouping, and in response to an association, apply the network user or user defined grouping color to the associated network devices'graphical user interface components, and network traffic charts, graphs, and visualizations, and network calendars, alarms, and notifications.

According to various embodiments, the network router may provide configuration of network controls through inheritance grouping. The process of duplicating a router configuration to multiple devices that use the same configuration settings often requires a careful replication performed by a trained user. In a traditional router configuration, this might mean making a copy of an existing table entry and then carefully changing the address to reference the new device. Even with the help of configuration aids, applying the same configuration across multiple network devices can be tedious and error prone.

In the example embodiments, a named device group can be used to simplify and accelerate the configuration process for network controls such as controls placed on network traffic, network activity, and the like, through inheritance. In addition, the named device group can be used to simplify and accelerate the configuration process of device settings including DHCP reservations, UPnP settings, port forwarding settings, category settings, country settings, hostname filters, Internet access settings, VPN usage settings, cross LAN access settings, preferred WAN access settings, notification configurations, notification schedules, and the like.

Each named device group can include multiple devices in the group. The configuration can be done once to the group to apply the same configuration settings to all of the network devices included in the group. Furthermore, a network device can be contained in more than one group so the configuration can be layered as additional settings are needed. Here, the network router may merge the configurations together to a final configuration of all of the settings based on a hierarchy between the different named groups. Lastly, a configuration can be overridden at any point in the inheritance structure. This enables a temporary halting of a configuration setting, as well as the restoration of the setting, without dismantling the normal configuration.

In some embodiments, the network router may display and configure a computer network router on a graphical user interface to facilitate the control of network traffic to any number of network devices. displaying a list of graphically represented network devices whose network access is controlled by the network router; and in response to selection, adding or removing the device to a named group of network devices. In some embodiments, the network router may display a list of graphically represented named groups of devices, and in response to a selection of a group, add or remove a device or named group of network devices. In some embodiments, the network router may incorporate all network devices supported by the network router into an inherit group of All Devices, of which all network devices are deemed to be a part. Here, the network router may enable network controls to be set simultaneously for all of the network devices at once based on configuration of a single group, etc. In addition, the network router may enable device settings such as DHCP reservations, UPnP settings, port forwarding settings, category settings, country settings, hostname filters, Internet access settings, VPN usage settings, cross LAN access settings, preferred WAN access settings, notification configurations, notification schedules, and the like, to be set simultaneously for all of the network devices at once based on configuration of a single group.

In some embodiments, the router may display a list of network controls for stopping, limiting, or redirecting network traffic, of which are controls to block all network traffic, allow only/block categories of network traffic, allow only/block list of hostnames, allow only/block region based content, redirect over a virtual private network (VPN), redirect search requests to safe search alternative; and in response to selection, applying the network controls to the named group of network devices. In some embodiments, the router may display a schedule to limit individual network controls to select times and days, of which are settings for start and end times, daily repeat to end date, repeat for one or more occurrences, particular days of weeks, particular days of week until end date, particular days of week until one or more occurrences.

In some embodiments, the network router may display a list of network controls for overriding a network control, and in response to a selection, apply the network control override to the named group of network devices. In some embodiments, the network router may merge one or more network controls and network control overrides where network controls and network control overrides are inherited from encapsulating (or ‘parent’) named groups, and from the All Devices group. For example, the merging may start with the “All Devices” network controls and network control overrides, and proceed with the network control and network control overrides of any encapsulating named groups of network devices, and complete with the network controls and network control overrides applied to the actual network device. Furthermore, the network router may apply the resultant merged network controls to the router configuration of network devices.

According to various embodiments, the network router may provide remote notifications of network router observations. Typically, a router provides a centralized overview of the devices to which it provides Internet access. Information such as an issue with a certain device or the router itself may be critical to know. With other routers, a user might be able to remotely access the router and manually determine this information if the user logs into a centralized cloud site, but the specific observations might be difficult or impossible to extrapolate and moreover lack the ability to be aware at the moment that an observation is made.

The example embodiments utilize a widely adopted technology of push notifications to facilitate the notification of this information. A user can selectively choose which events they would like to receive notifications. Here, the network router will then push notifications of the events to the devices that have used the app to sign onto the router. Additionally, for devices assigned to a named group, higher knowledge observations can be made in near real time such as when a user connects or disconnects from the network, which user accessed a concerning category of web sites, which group is consuming an excessive amount of data, what changes are being made to the router database, and the like.

In some embodiments, the network router may display a list of graphically represented types of network router observations which may include a new device on the network observation, a device online observation, a device offline observation, a device accessing a category of web sites observation, a device exceeding a set time limit observation, a device exceeding a set amount of data observation, and the like. In response to a selection, the network router may electronically configure the network router with the event criteria. In some embodiments, the router may display a list of graphically represented types of network router events for a named group of devices to include first online device of the named group of devices observation, last offline device of a named groups of devices observation, a device of a named group of devices accessing a select category of web sites observation, device of a named group of devices exceeds a set time limit observation, a device of a named group of devices exceeds a set amount of data observation. In response to a selection, the network router may electronically configure the network router with the network router events.

In some embodiments, the network router may display a list of graphically represented types of system observations to include excessive temperature observation, excessive flash usage observation, excessive memory usage observation, excessive CPU usage observation. In some embodiments, the network router. In some embodiments, the network router may display a list of graphically represented types of change observations to include password change observation, firmware change observation, database change observation, database remove observation, and the like. In some embodiments, the network router may display a list of graphically represented types of network interface and virtual interface observations to include new interface added observations, interface online observations, interface offline observations, interface device accessing a select category of web sites observations, interface device exceeding the time limit observations, interface device exceeding a set amount of data observations, and the like.

In some embodiments, the network router may display a list of graphically represented types of virtual private network, VPN, observations to include new VPN added observation, VPN online observation, VPN offline observation. In some embodiments, the network router may receive a selection, via the GUI, of one or more remote devices for receipt of system notifications, and in response to selection, electronically register the device for receipt of notices for the corresponding network router. In some embodiments, the network router may observe and coalesce network router packet data, system logs, history logs and hardware sensor data, and send a notification message in regard to the network router to registered recipients.

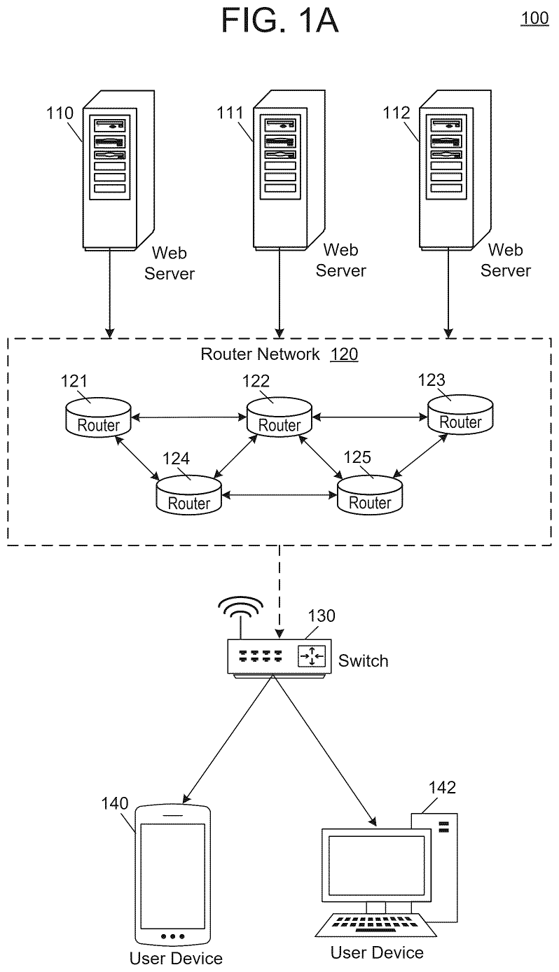

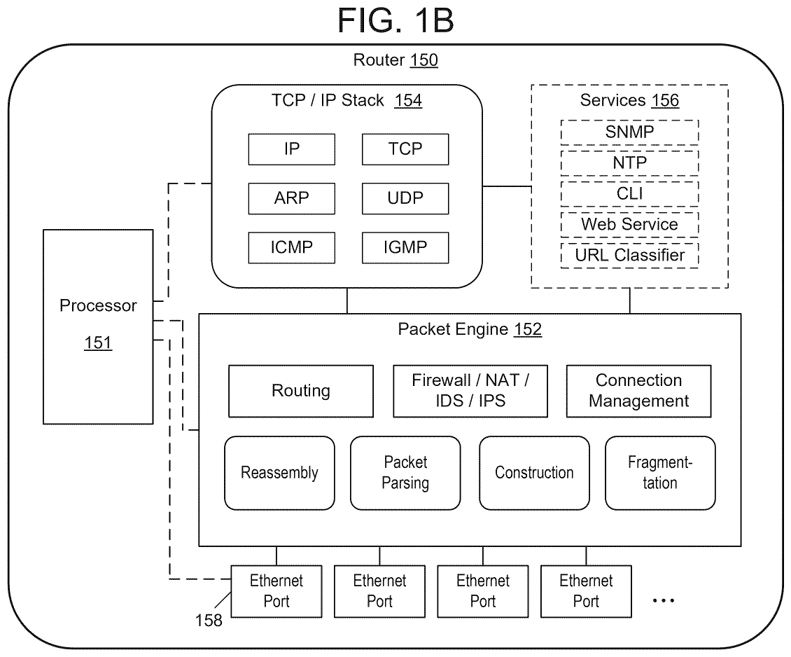

FIG. 1A illustrates a network computing environment 100 including a plurality of routing apparatuses (e.g., routers) according to example embodiments. Referring to FIG. 1A, the network computing environment 100 includes a plurality of web servers that provide content to a plurality of user devices. In this example, a web server 110, a web server 111, and a web server 112 may provide different types of content including emails, videos, chat, social media, video games, and the like, to a user device 140 and a user device 142 via a network of routers 120. In this example, the network of routers 120 includes a router 121, a router 122, a router 123, a router 124, and a router 125. Any of the routers within the network of routers 120 may embody the self-configuring and bitmap management processes described herein.

For example, the web server 110 may send packets of data to the user device 140 via the network of routers 120. In this example, one or more of the routers in the network of routers 120 may receive and route the packets until it reaches the user device 140. For example, a router 121 may receive the packets from the web server 110 and route the packets to the router 124. Here, the router 121 may select/choose the best path for the packets through the network. In response to receiving the packets, the router 124 may then route the packets to a switch 130, which then delivers the packets to the user device 140. The source and destination of the packets may be included in the packets and may be used by the network of routers 120 and the switch 130 to deliver the packet to the appropriate device (the user device 140).

Each of the routers in the network of routers 120 may store a routing table which includes all of the available paths in the network of routers 120. A router may look at the destination IP address in the packet and determine the fastest path through the network of routers 120 based on the routing table and metric values determined by the router. Furthermore, any of the routers within the network of routers 120 may perform the methods and processes described herein. For example, a router may automatically configure a VLAN interface, may enable direct access to a remote device, and/or may transparently replace an existing router on the network without a need for manual configuration.

The example of FIG. 1A could refer to a home environment or the like. It should also be appreciated that the routers described herein may be used in an office environment. In this example, the routers may connect not only user devices, but also other servers, and the like.

FIG. 1B illustrates components that may be included within a routing apparatus (i.e., a router 150) according to example embodiments. Referring to FIG. 1B, the router 150 includes a processor 151 such as a central processing unit (CPU) that helps each of the other components of the router 150 perform their function. The router 150 also includes a packet engine 152, a transmission protocol/Internet protocol (TCP/IP) stack 154, and a plurality of Ethernet ports 158. In this example, the packet engine 152 is responsible for processing packets as they are received through an ingress port (e.g., an Ethernet port 158) and output via an egress port. The TCP/IP stack 154 is responsible for ensuring that various protocols are enforced on packets from ingress to egress. The packet engine 152 and/or the TCP/IP Stack 154 may perform services 156 on packets that pass through the router 150 including, but not limited to, implementing a Simple Network Management Protocol (SNMP), implementing Network Time Protocol (NTP), providing and managing a command line interface (CLI), managing a web service that is accessible to external devices, and a uniform resource locator (URL) classifier.

According to various embodiments, the packet engine 152 may perform routing on a packet based on a destination IP address of the packet, may implement a firewall, perform network address translation (NAT), perform an instruction detection system (IDS), perform an intrusion prevention system (IPS), and the like. The packet engine 152 may also perform a connection management function to control automatic failover, monitor client connections, direct requests to appropriate servers, act as a proxy server, handle client/server communications, and prioritize connections between application servers. The packet engine 152 may also perform reassembly on fragments of a packet as it arrives and apply ACLs and NATs to the packet once it is reassembled, packet parsing, construction, and fragmentation of packets into smaller pieces so that resulting pieces can pass through a link with a smaller maximum transmission unit.

In some embodiments, the packet engine 152 may also manage autoconfiguration for IPV4 which enables devices to connect to the Internet automatically assign themselves an IP address, device management which displays views of router configuration and performance such as to an external device, virtual private networks (VPNs), routing information protocol (RIP), Universal Plug and Play (UPnP) to enable compliant devices to automatically set port forwarding rules, simple service discovery protocol (SSDP) which enables a device to advertise its services to other devices, a Domain Name System (DNS) which enables translation of domain names to machine-readable IP addresses, a hostname cache which can be used by the DNS store hostnames and IP address pairings, category enforcement which enables blocking of categories of DNS, device pause, and the like.

Furthermore, the packet engine 152 may also control and manage dynamic host configuration protocol (DHCP) including DHCP client and DHCP server functions. DHCP can be used to assign IP addresses to DHCP clients and allocate TCP/IP configuration information to DHCP clients. This information includes subnet mask information, default gateway IP addresses, and DNS addresses. In some embodiments, the router 150 may serve as a DHCP server that assigns IP addresses to clients connected to the router 150.

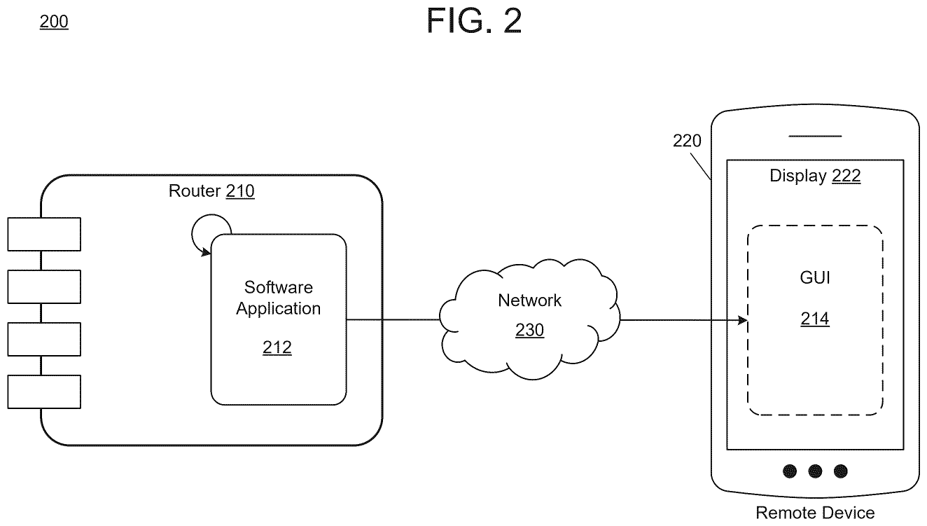

FIG. 2 illustrates a process 200 of a network router 210 outputting a graphical user interface (GUI) 212 to a remote device 220 over a computer network 230 according to example embodiments. Referring to FIG. 2, the network router 210 may be a network router according to the example embodiments described herein. In this example, the network router 210 includes a software application 212 installed therein which can output the GUI 214 on the remote device 220 and output content from the software application 212 to the GUI 214 which is output on a display 222 of the remote device 220. In this example, the remote device 220 may access the software application 212 by downloading a front-end of the software application and installing it locally on the remote device 220. As another example, the remote device 220 may access the software application 212 by visiting a web site or other address where the software application 212 can be accessed via a browser.

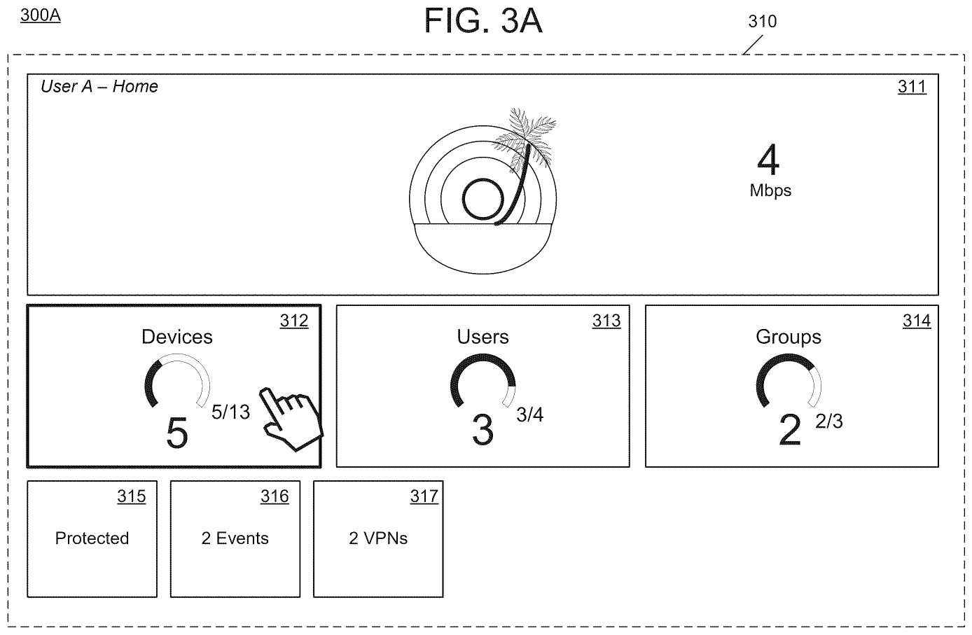

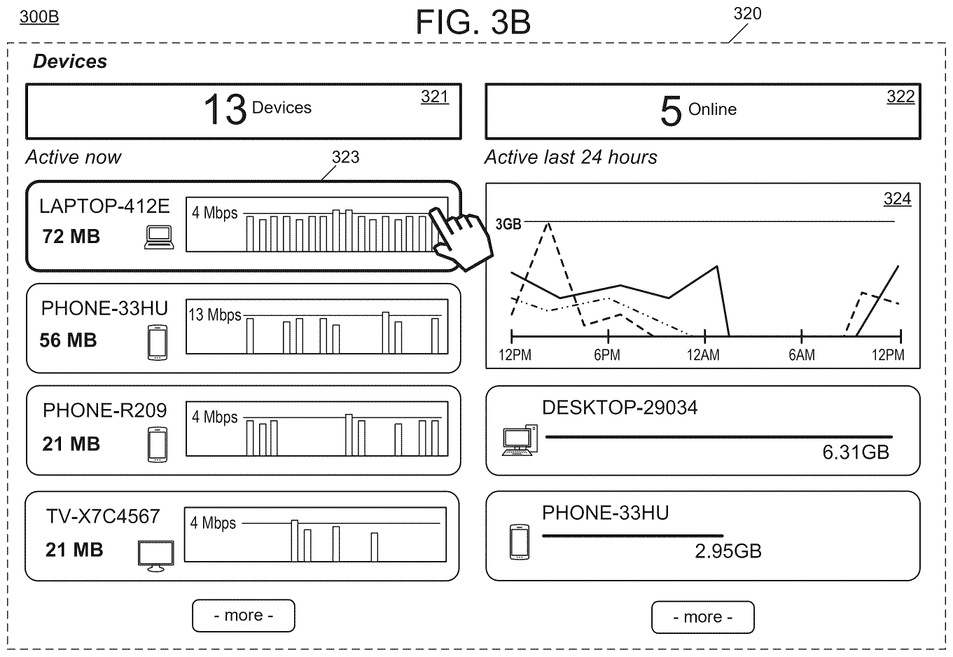

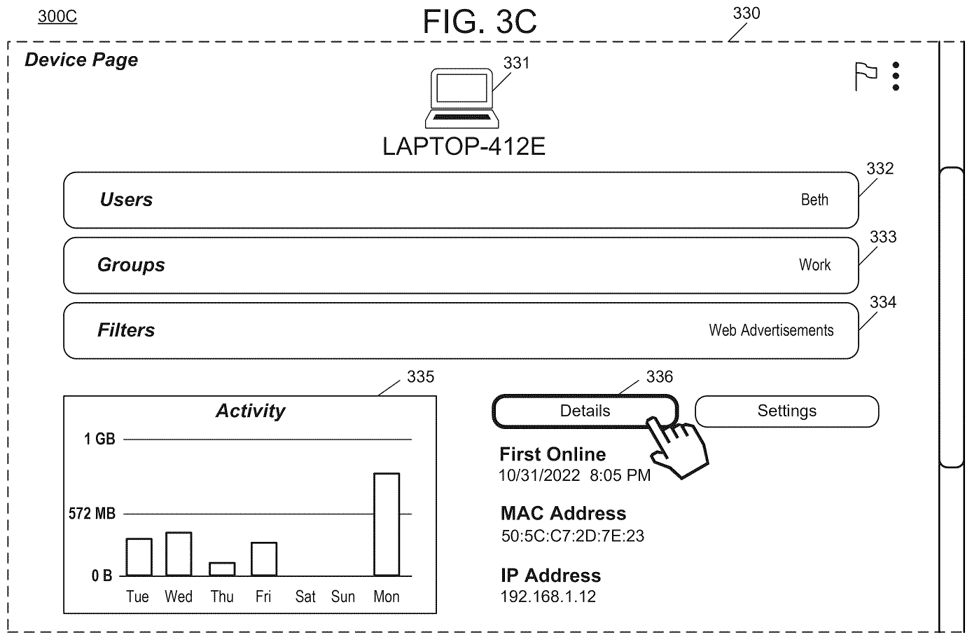

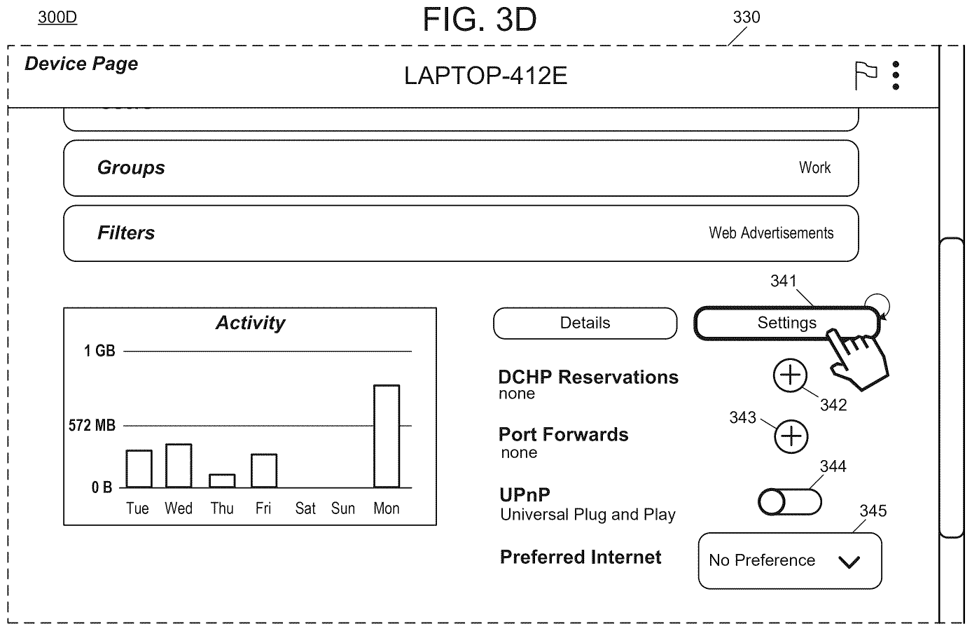

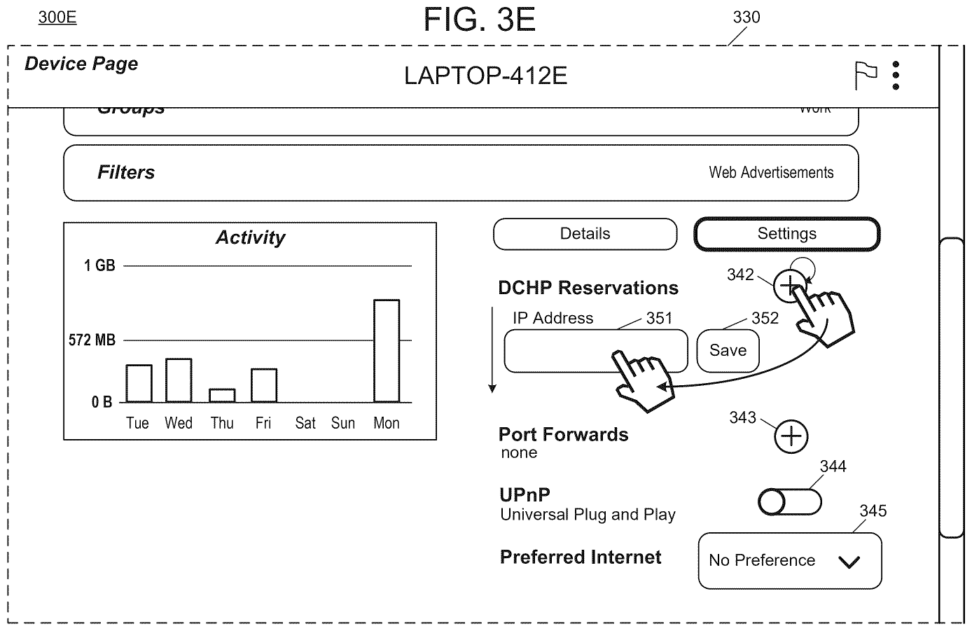

The following description includes examples of pages of content that can be output by the software application 212 to the GUI 214 displayed on the remote device 220. For example, FIGS. 3A-3E illustrate a process of configuring device-centric router settings through a GUI according to example embodiments. Furthermore, FIGS. 3A-3E illustrate examples of pages of content that may be output by the network router 210 to the remote device 220.

FIG. 3A illustrates a view 300A of a home screen 310 that may be output by a network router according to various embodiments. Referring to FIG. 3A, the home screen 310 includes home screen tile 311 with a value that represents how much network bandwidth is currently being consumed through the network router (e.g., 4 Mbps). The home screen 310 also include a device tile 312 that identifies how may total network devices (13) are managed by the network router and how many of the network devices are currently online (5). The network devices have their network access managed by the network router. The home screen 310 also includes a user tile 313 that identifies how may total users (4) are managed by the network router and how many of the users are currently online (3). The home screen also includes a group tile 314 that identifies how many total groups (3) are hosted by the network router and how many of the groups are currently online (2).

The home screen 310 may also include other tiles such as a tile 315 that identifies whether or not the network traffic is encrypted (e.g., protected), a tile 316 that identifies any network events that have been detected, and a tile 317 that identifies how many VPNs are managed by the network router. In this example, a user may touch one of the tiles on the home screen 310 to drill down into additional information/pages of content. As another example, a user may move a cursor using a mouse, keyboard, glance, etc. Here, the user selects the device tile 312 within the home screen 310. In response, the network router removes the home screen 310 and replaces it with a device page 320 as shown in the example of FIG. 3B.

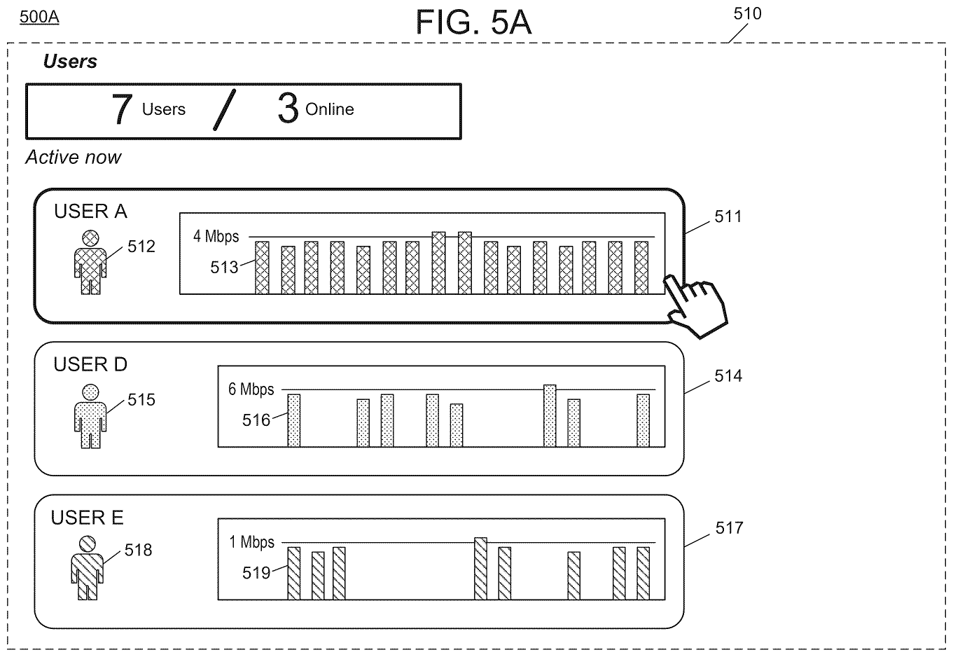

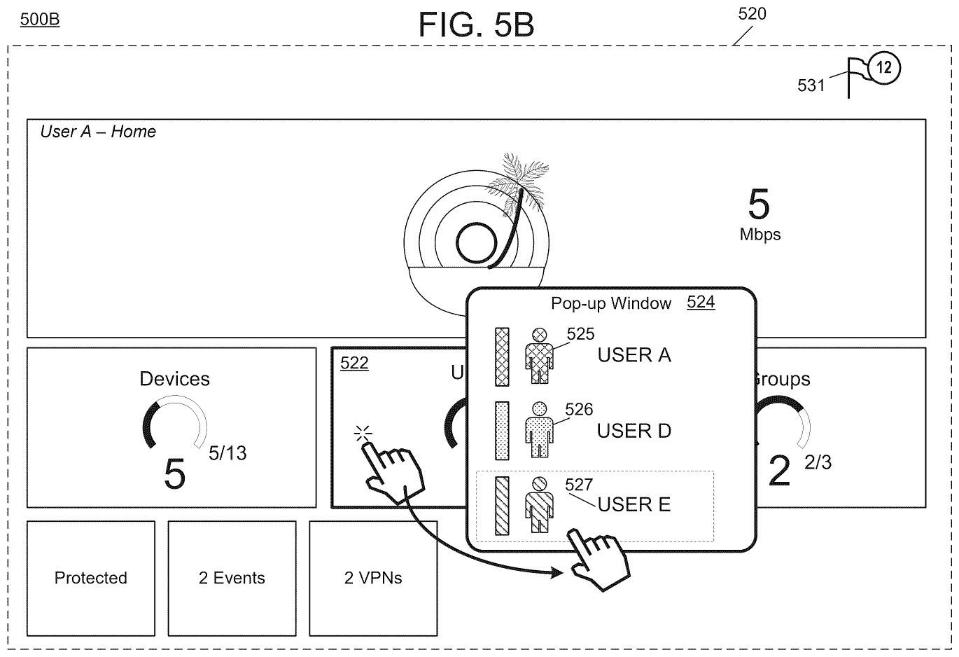

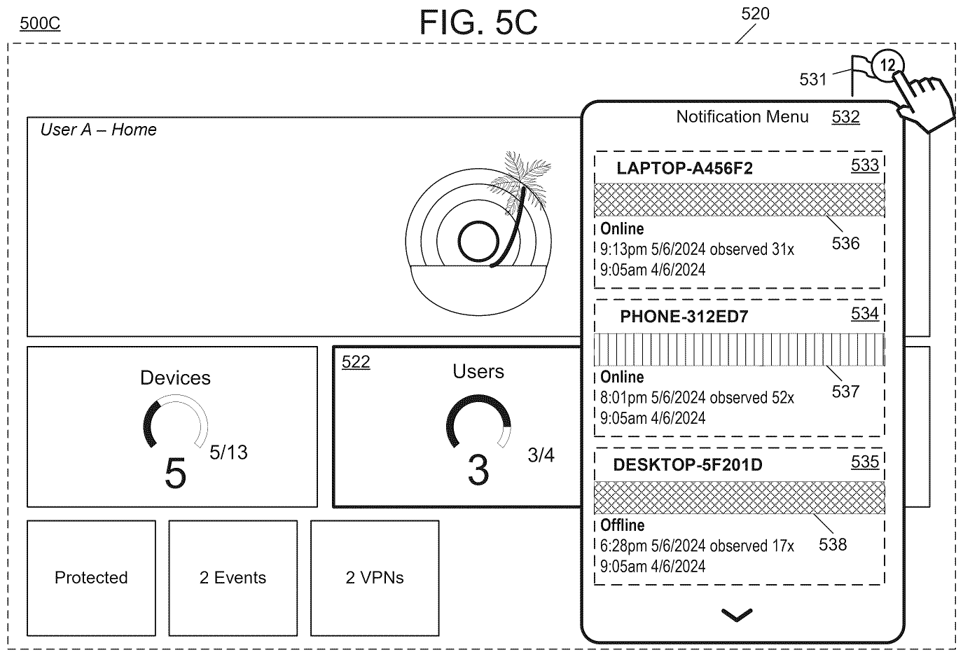

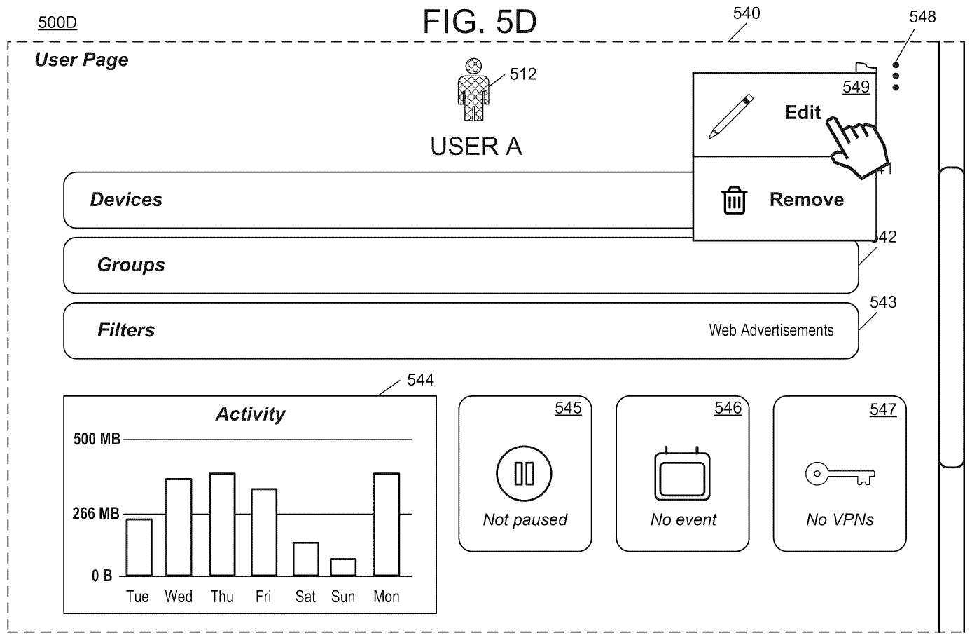

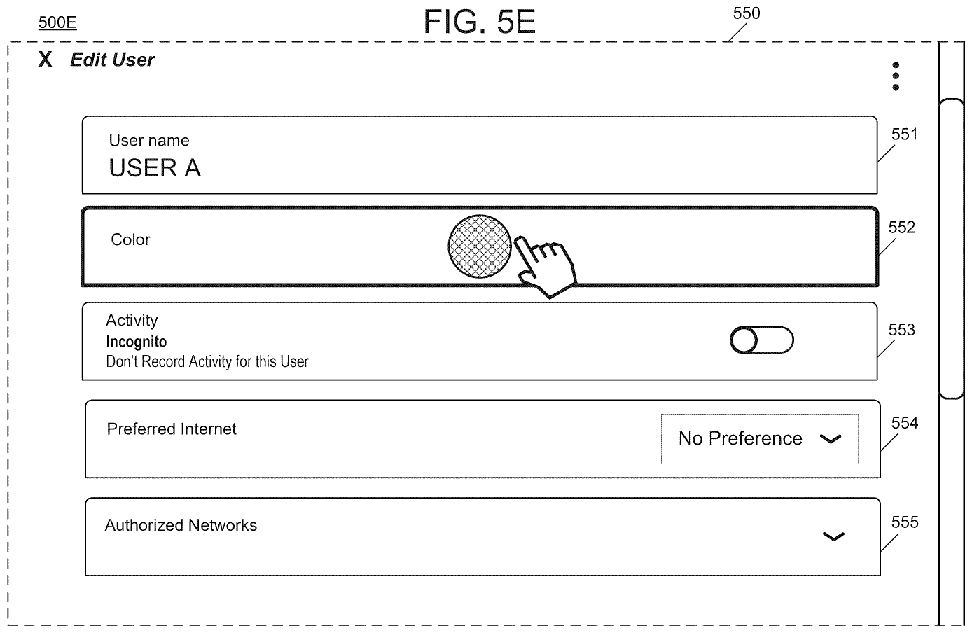

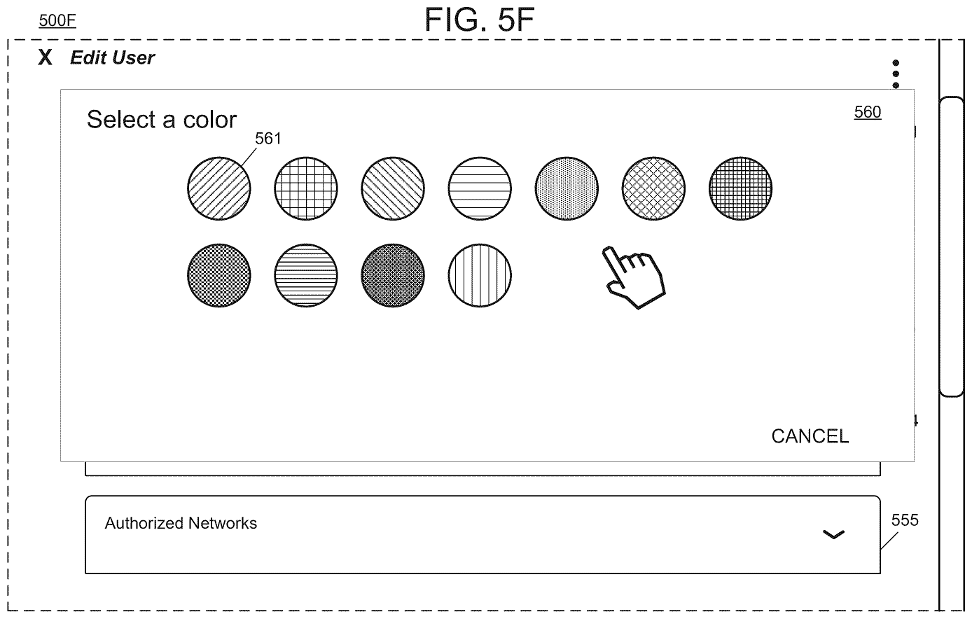

For example, FIG. 3B illustrates a view 300B of the device page 320 of the network router including a list of devices which have network access managed by the network router. In this example, tiles 321 and 322 can be used to identify how many total devices are served by the network router and how many of the total devices are currently online. Furthermore, for the devices that are currently active (online), a bubble 323 may be displayed within the device page 320 which includes an identifier of the network device (e.g., a name, an IP address, etc.) and network attributes of the network device (e.g., current bandwidth being consumed, bandwidth consumed over time, etc.). In addition, the device page 320 also includes an activity graph 324 which shows the network activity of the online devices for a period of time such as the past 24 hours, or the like. In some embodiments, the activity graph 324 may include colors as further described in the examples of FIGS. 5A-5F.

Here, the user may scroll down using commands and to view additional device activity information about the network devices that are served by the network router. Also, the user may click a bubble 323 of any of the network devices to view detailed information about a particular device including an IP address, any groups the device is a apart of, a user associated with the device, any filters/network controls placed on the device, and the like. In the example of FIG. 3B, the user selects the bubble 323 corresponding to the network device LAPTOP-412E. In response, the network router displays a device details page 330 as shown in FIG. 3C.

For example, FIG. 3C illustrates a view 300C of the device page 330 corresponding to the LAPTOP-412E. In this example, the device page 330 includes a user button 332 which can be selected to assign the device to a user, a groups button 333 which can be selected and used to assign the device to a named group, and a filter button 334 which can be selected to configure network controls for the network device. In addition, the device page 330 also includes an activity graph 335 with network activity information of the network device over a predetermined period of time (e.g., the last week, etc.)

According to various embodiments, the GUI (such as the device page 330) may also provide a details button 336 which displays the details about the network device that are automatically detected by the network router when the network device is first connected to the network router. In this example, the details include a time at which the network device is first detected online, an IP address, a MAC address, and the like. Here, the user may click on a settings button 341, as shown in FIG. 3D to review device-centric router configuring controls.

For example, FIG. 3D illustrates a view 300D of the device page 330 after the network settings button 341 has been pressed. In this case, the GUI may move content on the screen downward and/or upward to make room for device settings that can be interacted with on the page of the GUI such as DHCP reservations, port forwards, UPnP settings, category settings, country settings, hostname filters, Internet access settings, VPN usage settings, cross LAN access settings, preferred WAN access settings, notification configurations, notification schedules, and the like, for a particular device. Here, the user can use one or more controls 342, 343, and 344 to configure one or more of the router settings of the network device. That is, the user can configure router settings (e.g., stored in a routing table of the network router) for a particular network device through the controls 342, 343, and 344. As another example, the user may be able to set a preferred network connection tab 345 for the network device through the settings screen.

FIG. 3E illustrates a view 300E of the device page 330 after the user selects the control 342 corresponding to DHCP reservations. In response, the GUI moves the controls 343, 344, and 345 downward to make room for additional fields 351 and 352 which enable a user to input a reserved IP address for the network device, and to save the IP address reservation. Thus, a user can configure DHCP settings of the network device at the network router in a device-centric manner through the GUI according to example embodiments.

Another aspect of the network router described herein is that it has the ability to provide notifications about network events to a remote device, such as a mobile device, a desktop computer, a smart-wearable device, or the like. The software may provide notifications when a network device comes online, goes offline, is first noticed, and the like. As another example, the software may provide notifications when a network device accesses a particular category of content, when a network device is online for a certain amount of time, when a network device exceeds a certain volume of data for the day, when a network device is removed from the network, and the like.

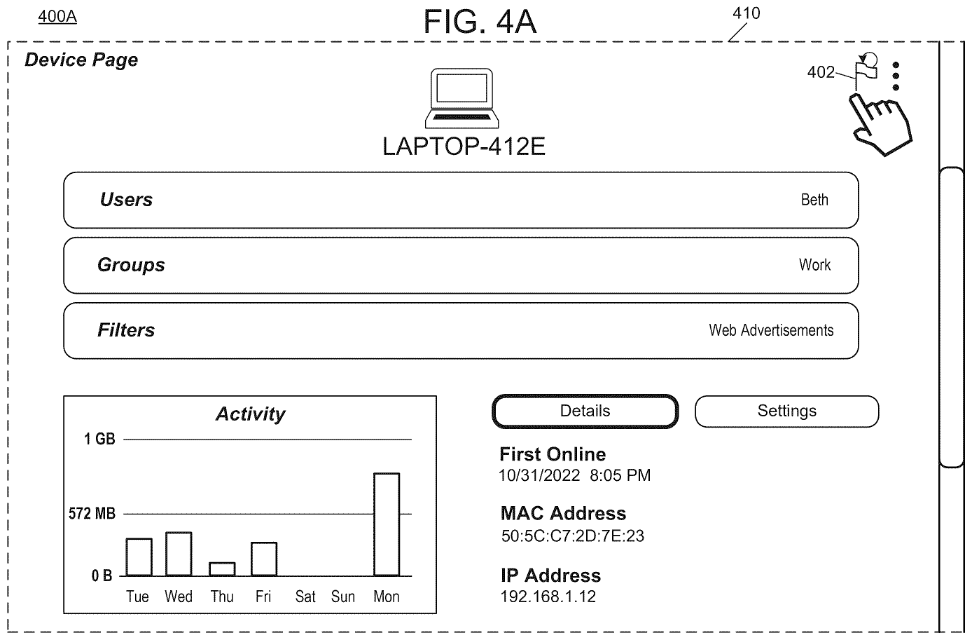

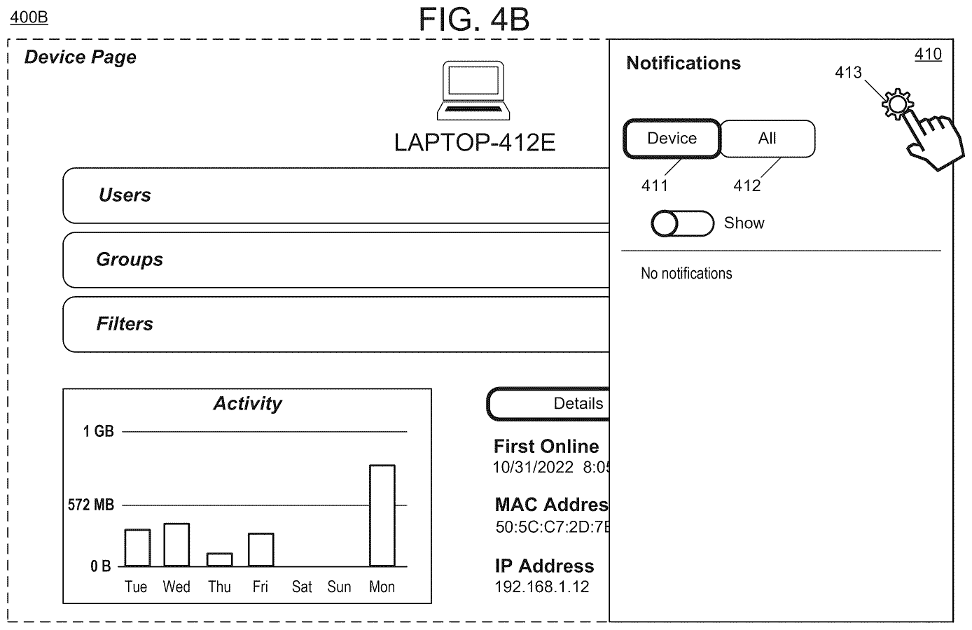

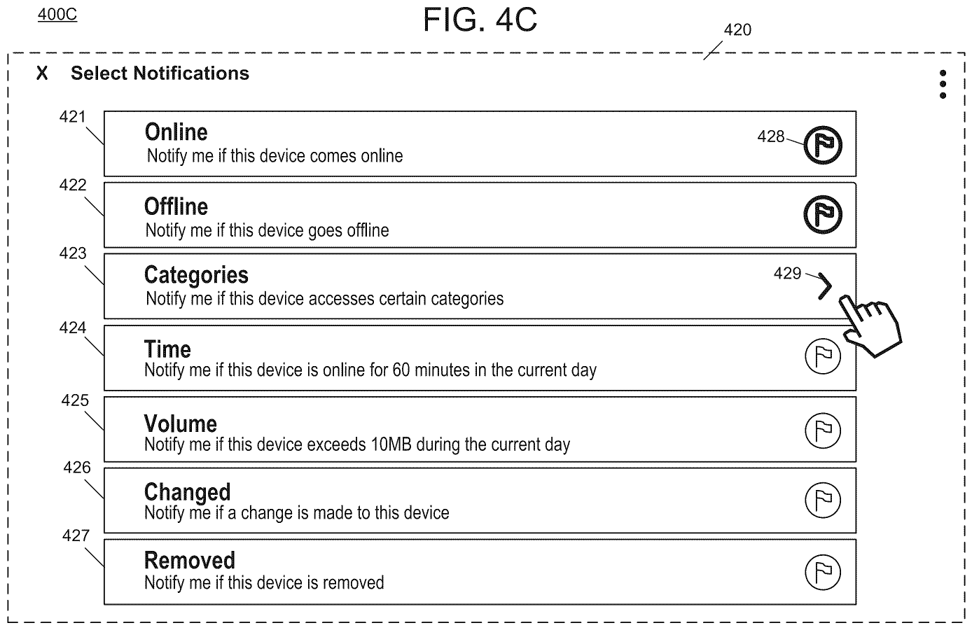

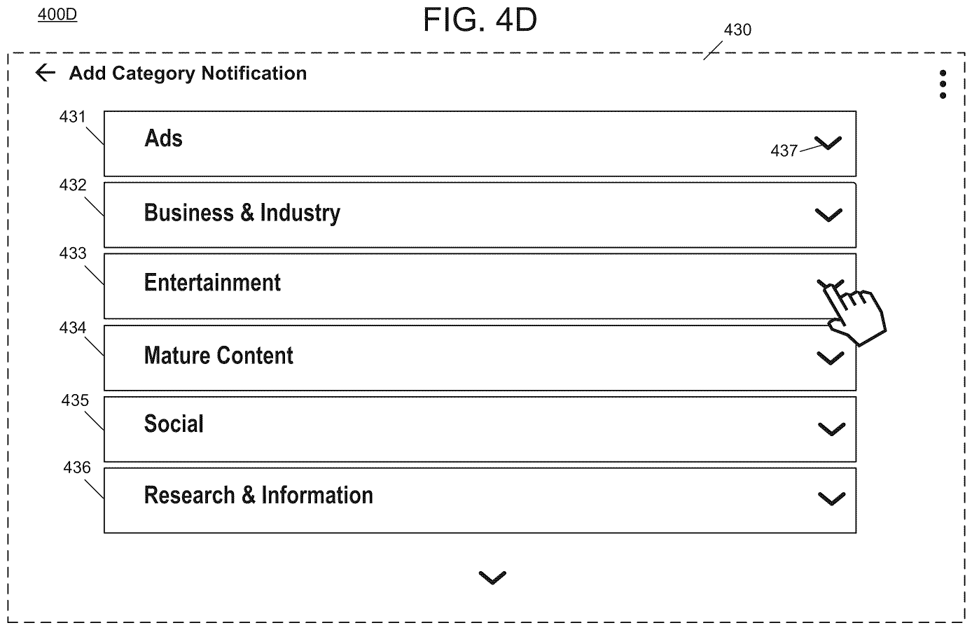

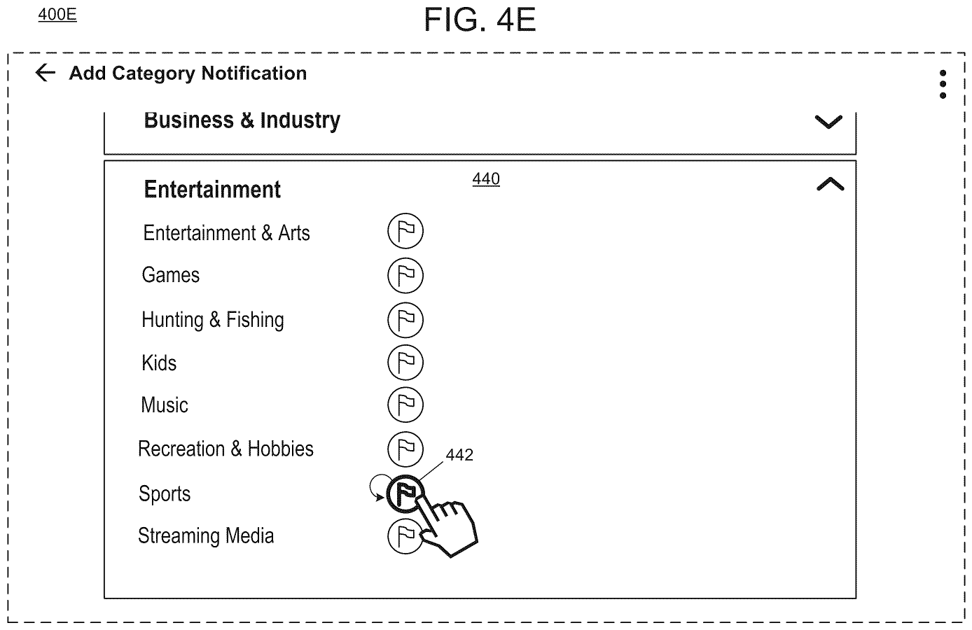

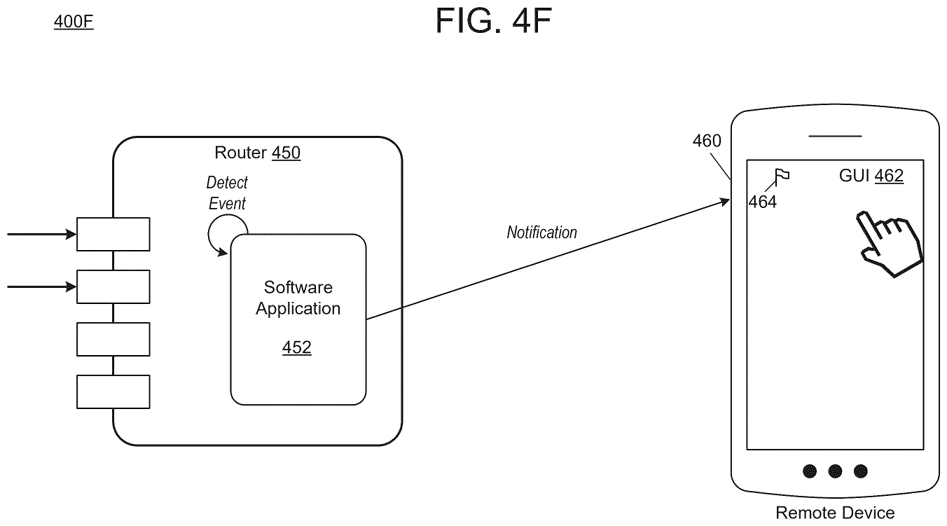

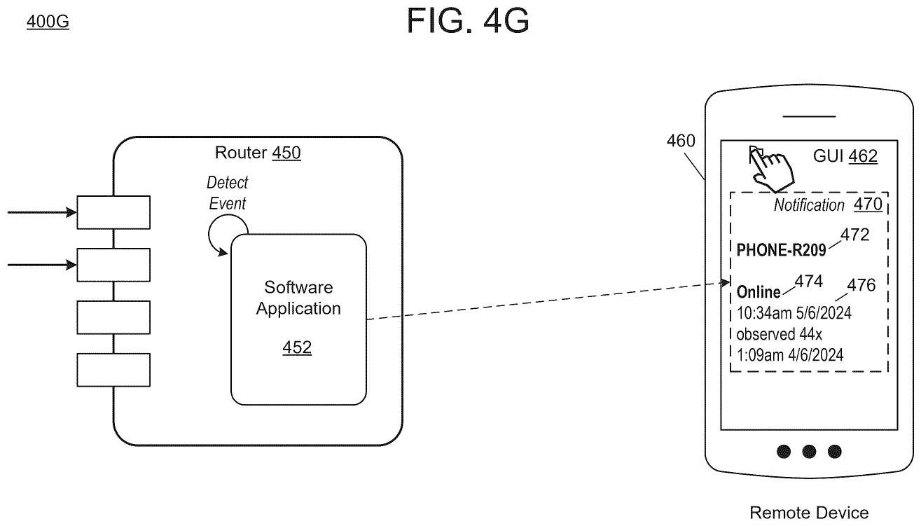

FIGS. 4A-4G illustrate a process of generating and outputting notifications from a network router to a remote device according to example embodiments. For example, FIG. 4A illustrates a view 400A of the device page 330. In this example, the user may press on a notifications tab 402 that is displayed on an upper corner of the device page 330. Here, the notifications tab causes the network server to display a notifications menu 410 as shown in the example of FIG. 4B. Referring to FIG. 4B, a view 400B of the notifications menu 410 being overlaid over existing content on the device page 330 is shown thereby blocking the content and providing new content over the top of the existing content. The notifications menu 410 may expand from a side border, drop-down from a top border, appear over the content, or the like.

Referring to FIG. 4B, the notifications menu 410 may show any current notifications (or notifications which have been output in the last predetermined period of time (e.g., 1 hour, 30 minutes, etc.) The user may choose to create new notifications using the notification menu 410. In this example, the notification menu 410 also includes two settings buttons including a device setting button 411 and an “all devices” settings button 412. The user may choose to set a notification for this particular device by selecting the device setting button 411. As another example, the user may choose to set a notification for all devices being served by the network router by selecting the all devices settings button 412. In this example, the user has selected the device setting button 411. In addition, the user has selected the settings button 413 which causes the network router to display a select notifications page 420 as shown in the example of FIG. 4C.

In particular, FIG. 4C illustrates a view 400C of the select notifications page 420 according to example embodiments. In this example, the user may setup various notifications for a device (or for all devices) depending on which button the user selects on the previous page (e.g., the device setting button 411 or the all devices setting button 412). That is, if the user selects the device setting button 411 on the notification menu 410 shown in FIG. 4B, the notifications chosen on the select notifications page 420 will be applied to only that particular device. As another example, if the user selects the all devices setting button 412 on the previous page, the notifications chosen on the select notification page 420 will be applied to all network devices being served by the network router.

The select notifications page 420 includes various tiles including an online tile 421, an offline tile 422, a time tile 424, a volume tile 425, a changed tile 426, and a removed tile 427 which each include an activation button 428 which can be selected by the user to enable notifications for those tiles. For example, by selecting the activation button 428 within the online tile 421, the user can activate a notification each time the device comes online. When the activation button 428 is selected, the appearance of the activation button 428 may change, for example, may become highlighted, may become a different color, bolded, or otherwise modified to indicate that it has been selected.

Likewise, by selecting a similar activation button displayed within the offline tile 422, the user can activate a notification each time the device goes offline. Other notifications are also possible including when a user is online for more than a particular amount of time, when the user consumes more than a particular amount of data, when a device is changed, when a device is removed from a network, and the like. The user may also deactivate the notification by selecting the activation button 428 again. When the activation button 428 is selected again causing the notification to be turned off, the activation button may also return to its original state / appearance in which the activation button 428 is not highlighted.

In addition to the tiles that enable activation/deactivation of notifications, the select notifications page 420 also includes a categories tile 423 which includes a drill-down button 429 that can be selected causing a display of various categories of online content for which notifications can be set. In response to selecting the drill-down button 429 on the notifications page 420, the network router may output an add category notification page 430 as shown in the example of FIG. 4D. For example, FIG. 4D illustrates a view 400D of an add category notifications page 430. The add category notification page 430 includes various tiles for different categories of web content that can be selected for notifications. Here, the tiles include an advertisement tile 431, a business and industry tile 432, an entertainment tile 433, a mature content tile 434, a social tile 435, and a research and information tile 436.

The user may select a drop-down button 437 on any of the tiles to reveal specific types of content within each category that can be selected for notifications. In this example, the user selects the drop-down button 437 within the entertainment tile 433 which causes the network router to display a drop-down menu 440 as shown in the example of FIG. 4E.

For example, FIG. 4E illustrates a view 400E of the drop-down menu 440 being displayed based on the selection made by the user in FIG. 4D. Here, the drop-down menu 440 includes specific categories of entertainment (e.g., entertainment and arts, games, hunting and fishing, kids, music, recreation and hobbies, sports, and streaming media, etc.) which can have the individual notifications activated/deactivated by pressing on an activation button 442. Each specific category has its own activation button 442 thereby enabling the user to select specific categories of entertainment for which notifications should be received.

FIG. 4F illustrates a process 400F of sending a notification from a network router 450 to a remote device 460 according to example embodiments. The remote device 460 may be a device that is registered to receive notifications from the network router 450, for example, through a registration process. The remote device 460 may be a device that includes an Internet connection to the network router, such as a mobile device, desktop, personal computer, or the like. Referring to FIG. 4F, the network router 450 includes a software application 452 installed and running therein which can detect categories of web content being accessed by a device (or multiple devices) based on network traffic passing into and out of the ports of the network router 450. In the example of FIG. 4F, the network router 450 detects a network device coming online from the network traffic. In response, the software application 452 generates a notification and transmits the notification to the remote device 460. In this example, the network device that comes online may be a different device than the remote device 460. In some embodiments, the remote device 460 may not be connected/served by the network router 450 at the time the notification is generated and sent.

The network router 450 may cause a notification icon 464 to be displayed on a home screen being displayed on a graphical user interface 462 of the remote device 460. Here, the home screen may be a lock screen, a login screen, a start screen, or the like. Here, the notification icon 464 can be selected by a user via the GUI 462 displayed on the remote device 450 to provide additional information about the notification sent from the network router 450.

FIG. 4G illustrates a process 400G of the GUI 462 revealing additional information about the notification in response to the user selecting the notification icon 464. Here, the selection of the notification icon 454 reveals a notification message 470 with additional information about the notification generated by the network router 450 including an identifier 472 of the network device, an identifier 474 of the event detected by the network router 450, and additional details 476 about the event such as a time of the event, a number of occurrences of the event over a predetermined period of time, and the like.

In this case, the notification icon 464 may be similar to an email notification or the like which initially is collapsed and shown on a top border of the GUI 462 of the remote device 460. By selecting the notification icon 464, the user can receive additional details about the event.

According to various embodiments, the network router described herein may also enable rapid identification of users on the network through the use of colors. In particular, each user may be assigned a different color (or a different shade of a color). Furthermore, network devices, notifications, activity charts, and the like, associated with the user may also be displayed with the same color assigned to the user thereby letting a viewer quickly understand which user the displayed information is related to by simply seeing the color.

For example, many devices have names that are difficult to remember. Furthermore, many users are not familiar with how to change the name of their device. By assigning a color to a network device, a user can easily remember which colors are assigned to which users and understand who the network device corresponds to without needing to remember the name of the network device of each user. As an example, a child may be assigned a blue color (boy) or a pink color (girl), many different options are also possible. In addition, certain colors (e.g., green, red, yellow, etc.) may be reserved for specific functions of the router and may not be assigned to a user.

The examples of the notification types shown in FIGS. 4C-4E are for purposes of example, and should not be construed as limiting the types of notifications that can be set through the GUI of the example embodiments. Therefore, it should be appreciated that other types of notifications, not shown, may also be set through the GUI described herein.

FIGS. 5A-5F illustrate a process of identifying network devices through color selection according to example embodiments. For example, FIG. 5A illustrates a view 500A of a user activity page 510 output by the network router. In this example, named users are assigned colors previously by the network router. The assignment of colors may be by default (by the router) or it may be performed based on inputs by a viewer of the software. In this example, the user activity page 510 includes identifiers of each named user that is currently online/active including a first user tile 511 that includes a first user icon 512 identifying a first named user, a second user tile 514 that includes a second user icon 515 that identifies a second named user, and a third user tile 517 that includes a third user icon 518 that identifies a third named user.

In addition, each user tile includes activity data of the users over a predetermined period of time (e.g., the past 24 hours, etc.). For example, the first user tile 511 includes network activity chart 513 of the first named user, the second user tile 514 includes a network activity chart 516 of the second named user, and the third user tile 517 includes a network activity chart 519 of the third named user. The user icons and the activity charts may be shown in colors that are assigned to the respective named users. For example, the first user icon 512 and the network activity chart 513 may be shown in a first color (e.g., purple) assigned to the first named user. The second user icon 515 and the network activity chart 516 may be shown in a second color (e.g., blue) assigned to the second named user. Likewise, the third user icon 518 and the network activity chart 519 may be shown in a third color (e.g., pink) assigned to the third named user. Thus, each user may be assigned a different color. Furthermore, the color may be shown in various graphical elements output on the GUI by the network device including charts, graphs, icons, notifications, and the like.

FIG. 5B illustrates a view 500B of a home screen 520 output by the network router according to various embodiments. Referring to FIG. 5B, the home screen 520 includes various tiles which can be selected to drill-down into additional information about the network, the network devices, the named users, the named user groups, and the like. In this example, a viewer may use a cursor, a finger, or the like to select a tile 522 corresponding to the named users. Here, the home screen 520 may output a pop-up window 524 which shows identifiers of the active named users that are currently using the network router. In this example, there are three named users corresponding to the first named user, the second named user, and the third named user shown in FIG. 5A. Here, the software may display the user identifiers 525, 526, and 527, corresponding to the first named user, the second named user, and the third named user, respectively. This enables a viewer to quickly understand who the named users are, even when the named users are given names that are not familiar to the viewer. At the top of the home screen 520 shown in FIG. 5B is a notifications icon 531.

FIG. 5C illustrates a view 500C of the home screen 520 after the viewer presses the notification icon 531 on the top-right corner of the screen. Referring to FIG. 5C, the software may display a notification menu 532 as an overlay over the content of the home screen 520 in response to the selection of the notification icon 531. The notification menu 532 may include a list of notifications detected and generated by the network router over the past predetermined period of time (e.g., 1 hour, 4 hours, 12 hours, 24 hours, 1 week, etc.) Each of the notifications may refer to network devices. To visually identify the named users that are associated with each device, the software may use color within the notifications.

For example, a notification 533 corresponding to a first device may be displayed with a color 536 assigned to a named user of the first device. Meanwhile, a notification 534 corresponding to a second device may be displayed with a color 537 assigned to a named user of the second device. Likewise, a notification 535 corresponding to a third device may be displayed with a color 538 assigned to a named user of the third device. When two devices are associated with the same named user, the content associated with the two devices may be displayed with the same color thereby notifying viewers that each device is associated with a single named user.

FIG. 5D illustrates a view 500D of a user page 540 according to example embodiments. Here, the user page 540 may be navigated to from the home screen 520 by selecting one of the named users shown in the pop-up window 524 shown in FIG. 5B. In this example, the user page 540 corresponds to the first named user including the first user icon 512. The user page 540 also includes a device tile 541, a group tile 542, a filter tile 543, an activity chart 544, a pause tile 545, an event setting tile 546, and a VPN tile 547. In this example, the viewer presses on a settings button 548 in a top corner of the user page 540 which causes the software to display a pop-up window 549 which enables the viewer to edit attributes of the first named user, or remove the first named user. In this example, the viewer presses on the edit button within the pop-up window which triggers a user edit page 550 as shown in the example of FIG. 5E.

FIG. 5E illustrates a view 500E of the user edit page 550 according to example embodiments. Referring to FIG. 5E, the user edit page 550 includes a username tile 551, a color selection tile 552, an activity tile 553, a preferred Internet tile 554, and an authorized network tile 555. Here, the viewer may press on any of the tiles to edit preferences of the named user or change preferences of the named user such as the username, the color, the activity recognition, the preferred Internet, and the authorized networks. In the example of FIG. 5E, the viewer presses on the color selection tile 552 which causes the software to display a color palette as shown in the example of FIG. 5F.

For example, FIG. 5F illustrates a view 500F of a color palette page 560 which includes a palette of colors that the viewer can use to assign a particular color to the named user. In this example, the color palette page 560 is overlaid on the user edit page 550. In this example, the user may select any of the bubbles 561 corresponding to different colors to assign a color to the named user. The color palette may dynamically show only the colors that are not being used by other named users of the network. In other words, the software can prevent two different users from being assigned the same color by dynamically populating the color palette page 560 with only the colors that are not being used/assigned to other users. To do this, the software may keep a mapping of named users to currently assigned colors, and may reference the mapping when populating the color palette page 560.

According to various embodiments, the GUI provided herein by the network router may enable inheritance of network controls to devices of a named group. Different devices can be added to a particular named group through the GUI. Furthermore, the GUI can be used to set network controls for the group using a single setting menu, and the network controls can be simultaneously applied to the plurality of devices in the named group by the network router. This may include making changes to a routing table of the network router, changing traffic controls, blocking traffic, pausing a network connection in real-time, restoring a network connection in real-time, scheduling controls for the future, and the like. In addition, the GUI can be used to set DHCP reservations, UPnP settings, port forwarding settings, category settings, country settings, hostname filters, Internet access settings, VPN usage settings, cross LAN access settings, preferred WAN access settings, notification configurations, notification schedules, and the like, for all of the network devices at once based on configuration of a single group.

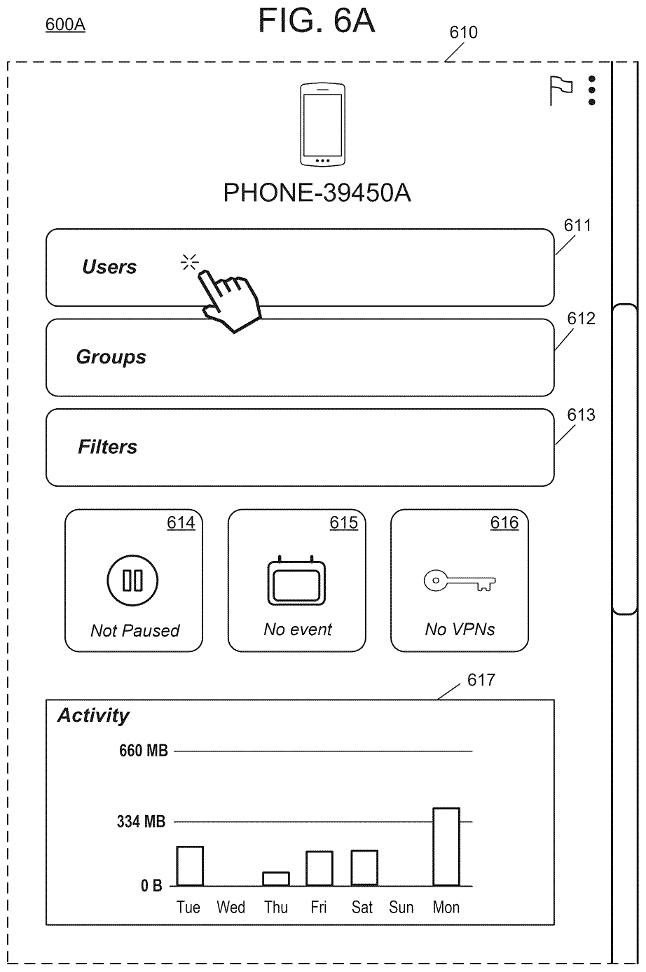

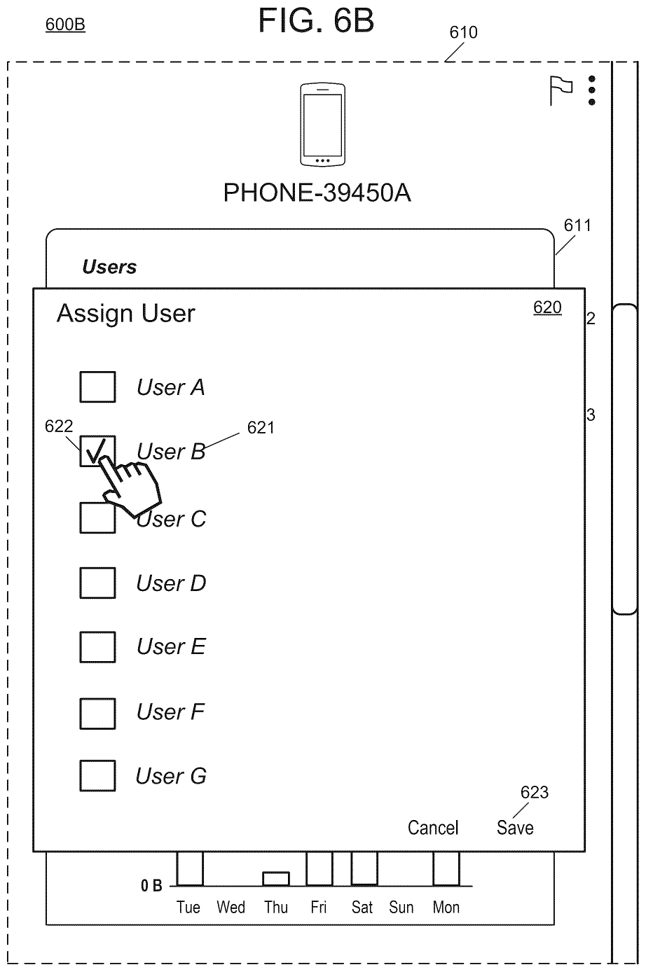

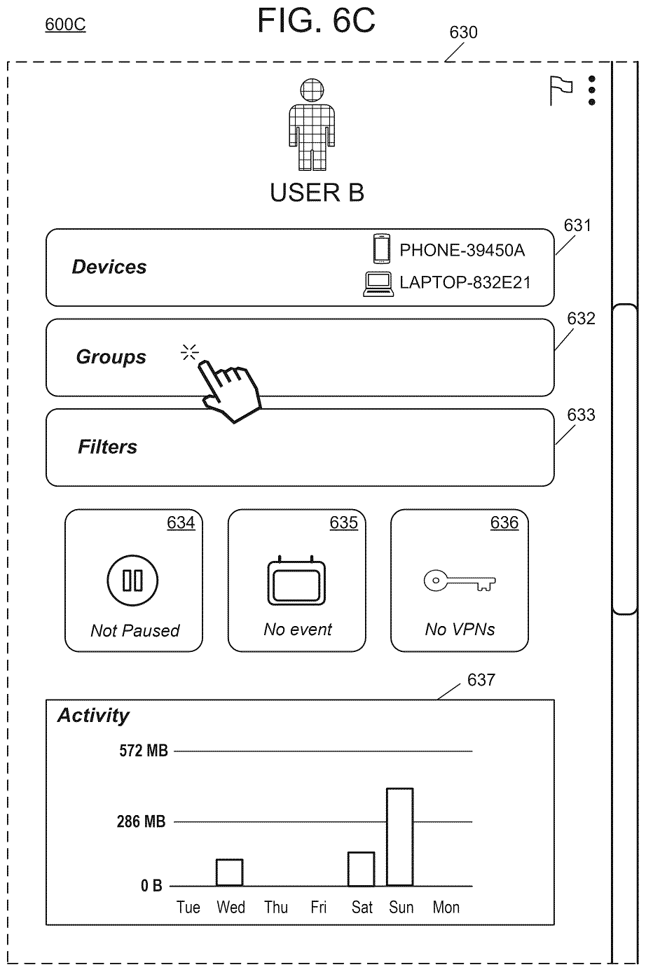

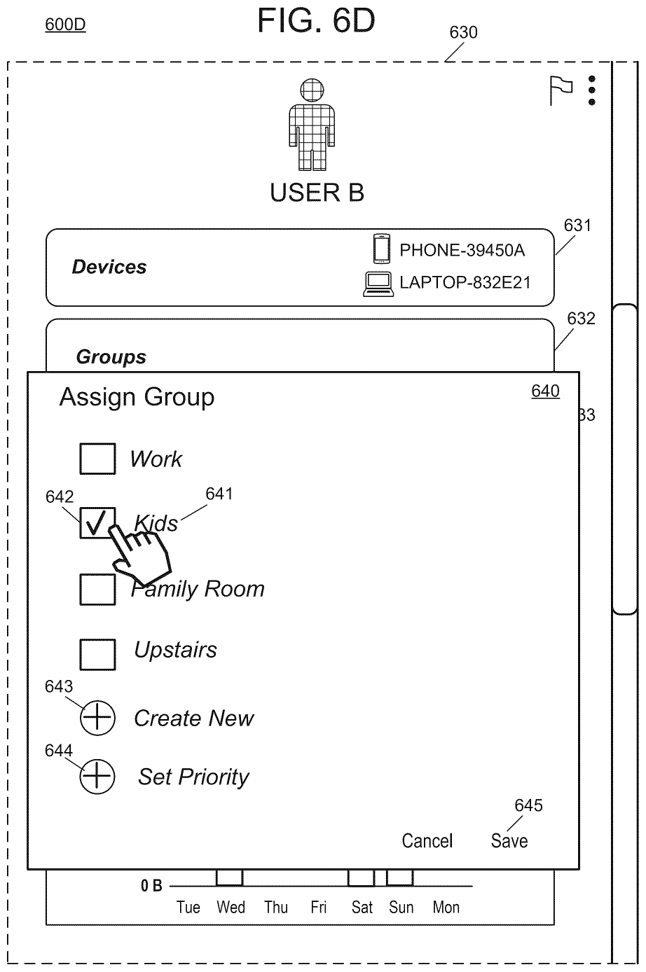

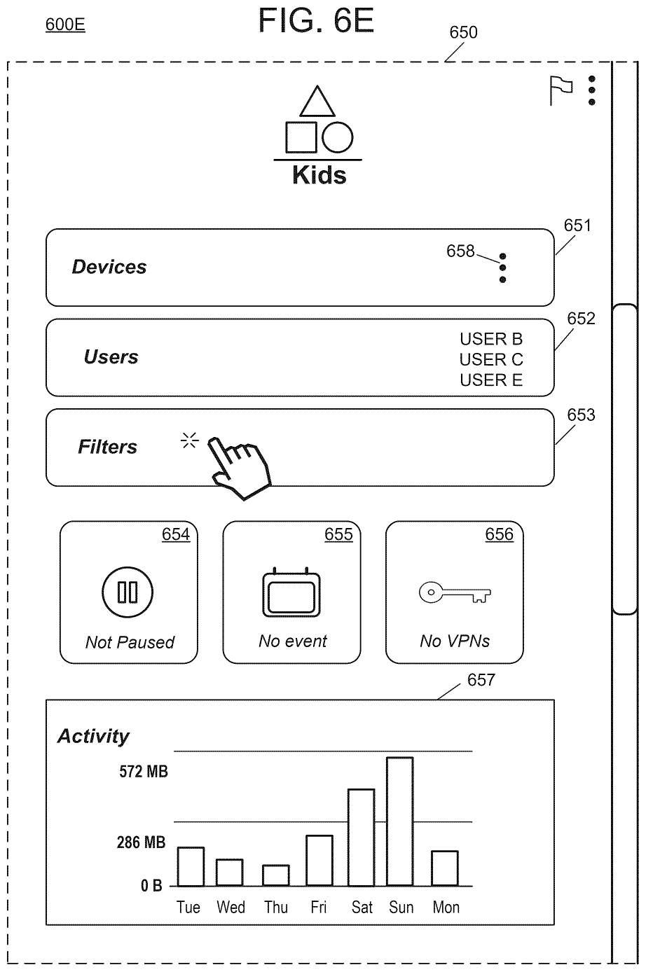

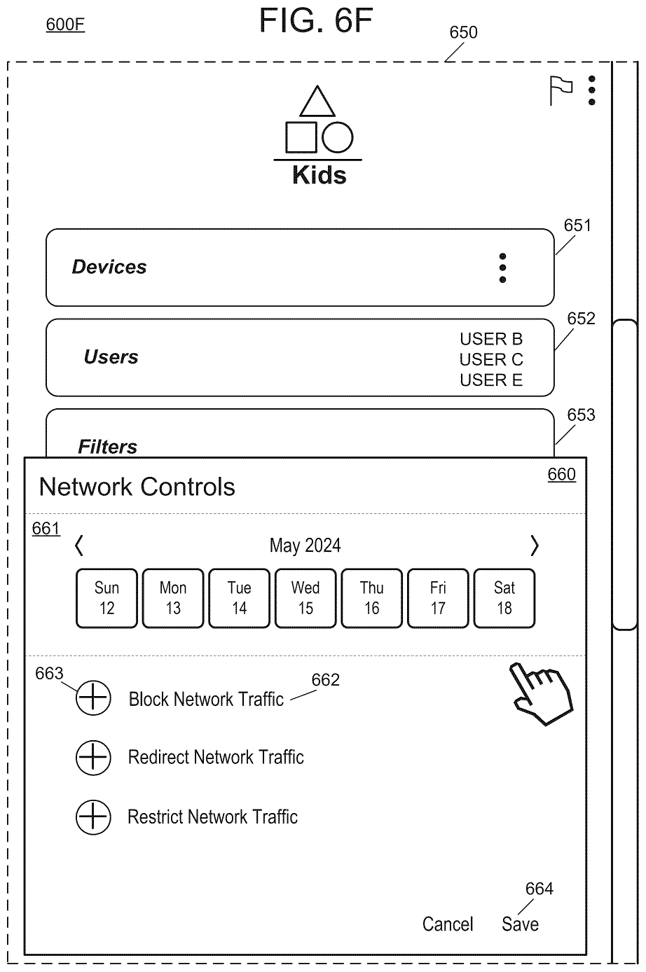

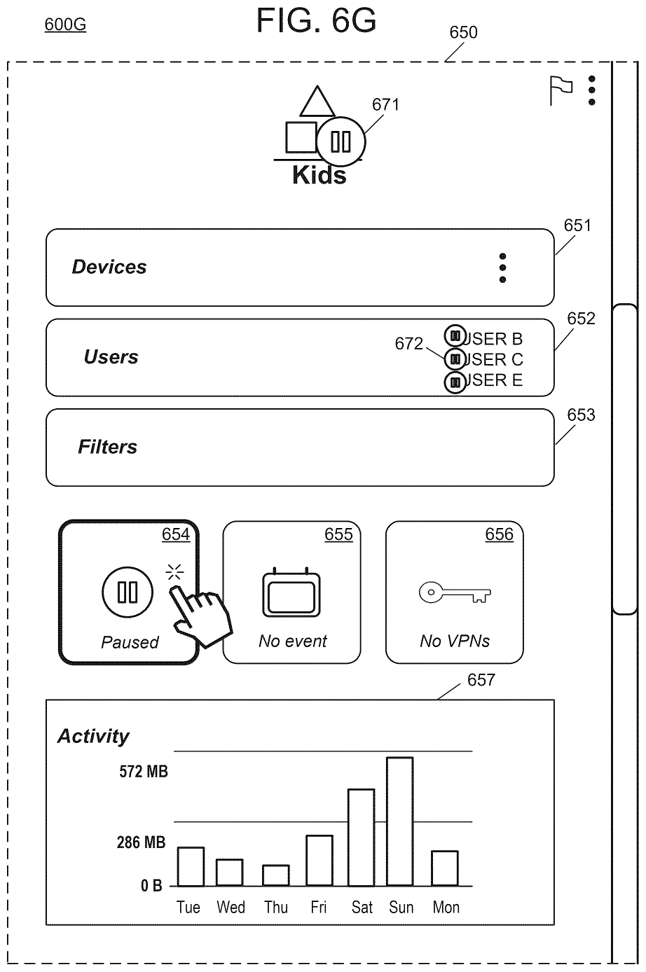

FIG. 6A illustrates a view 600A of a device page 610 according to example embodiments. In this example, the device page 610 corresponds to a laptop (network device) that has network access controlled by the network router. Referring to FIG. 6A, the device page 610 includes a named users tile 611, a named groups tile 612, a filters tile 613, a pause tile 614, an event tile 615, a VPN tile 616, and an activity chart 617. In this example, the viewer selects the named users tile 611 within the device page 610. In response, the software displays a pop-up window 620 as shown in the example of FIG. 6B.

For example, FIG. 6B illustrates a view 600B of the pop-up window 620 which includes controls for assigning a user to the network device associated with the device page 610. Here, the pop-up window 620 includes a list of all named users of the network router and checkboxes which enable the viewer to assign a user to the network device. In this example, the viewer can assign a named user 621 to the network device by selecting a checkbox 622 associated with the named user 621. Furthermore, the viewer may select a save button 623 when the assignment is finished.

FIG. 6C illustrates a view 600C of a user page 630 that may be accessed from different screens of the software according to various embodiments. Here, the user page 630 represents a named user of the network server and includes a devices tile 631 which enables a viewer to assign different devices to the named user. The devices tile 631 also includes identifiers of the devices currently assigned to the named user within the devices tile 631. The content in the devices tile 631 may change when a new device is assigned to the named user or a device is removed from the named user.

The user page 630 also includes a named groups tile 632 that enables the named user to be assigned to named groups. The user page 630 also includes a filter tile 633 for establishing network controls, a pause tile 634, an event tile 635, and a VPN tile 636. The user page 630 also includes an activity chart 637 that shows the network activity of the user over a predetermined period of time (such as the last week, etc.) In this example, the viewer may select the named groups tile 632. In response, the software may display a pop-up window 640 as shown in FIG. 6D.

For example, FIG. 6D illustrates a view 600D of the pop-up window 640 which enables a viewer to assign the named user associated with the user page 630 to a named group of the network router. Referring to FIG. 6D, the pop-up window 640 includes identifiers of different named groups that can be assigned, and checkboxes next to the named groups for selecting the assignment of the named groups. The pop-up window 640 also includes a control 643 for creating a new named group and a control 644 for setting a priority/hierarchy between the named groups.

The priority can be used by the software to determine network controls for a named user when the named user is apart of more than one named group. For example, when a user is assigned to two different named groups, and the two different named groups have a conflicting network control/setting, the priority may be used to choose which network control to apply to the user. As another example, the priority/hierarchy may be set by default by the software itself. In this example, the viewer assigns a named group 641 to the named user by selecting a checkbox 642 corresponding to the named group 641 within the pop-up window 640. The viewer may press a save button 645 to save the assignment.

FIG. 6E illustrates a view 600E of a named group page 650 of the network router according to example embodiments. Referring to FIG. 6E, the named group page 650 includes a devices tile 651, a users tile 652, a filters tile 653, a pause tile 654, an event tile 655, and a VPN tile 656. The named group page 650 also includes an activity chart 657 that shows the network activity of the named group over a predetermined period of time (such as the last week, etc.) The devices tile 651 may include identifiers of the network devices assigned to the named group within the tile itself. However, when there are too many network devices to fit within the display area of the devices tile 651, the software may display an icon 658 which can be selected to drill down on the devices therein.

In the example of FIG. 6E, the viewer may select the filters tile 653 to select network controls that can be assigned to the named users of the named group associated with the named group page 650. By clicking on the filters tile 653, the software may display a pop-up window 660 with network controls for setting network controls of the named group.

FIG. 6F illustrates a view 600F of the pop-up window 660 which includes settings and input mechanisms for setting network controls for the devices/named users of the named group all at once. Here, the pop-up window includes different controls 663 for setting different restrictions 662 such as blocking network traffic, redirecting network traffic, and restricting / limiting network traffic. In addition, the pop-up window 660 also includes a calendar 661 which enables the viewer to set the network controls for a specific period of time in the future. Once the controls are set, the viewer may press on the save button 664. By setting the network controls once for the named group, the network controls may simultaneously be applied by the network router to the named users/network devices of the named group. Here, the network router may make changes to routing tables, and the like, within the network router in response to the controls set for the named group.

FIG. 6G illustrates a process 600G of pausing network access to a named group of devices in real-time according to example embodiments. Referring to FIG. 6G, the named group page 650 is shown again. In this example, the viewer presses the pause tile 654 causing the network router to stop the network connection to the network devices of the named users assigned to the named group in real-time. The user may undo the network pause by clicking on the pause tile 654 again. In this example, the software may display a pause icon/button within the different graphical elements to signify that the group, devices, users, etc. are paused. For example, the graphical element that represents the named group may include a pause logo displayed therein. Likewise, a named user identifier 672 may be populated with a pause logo.

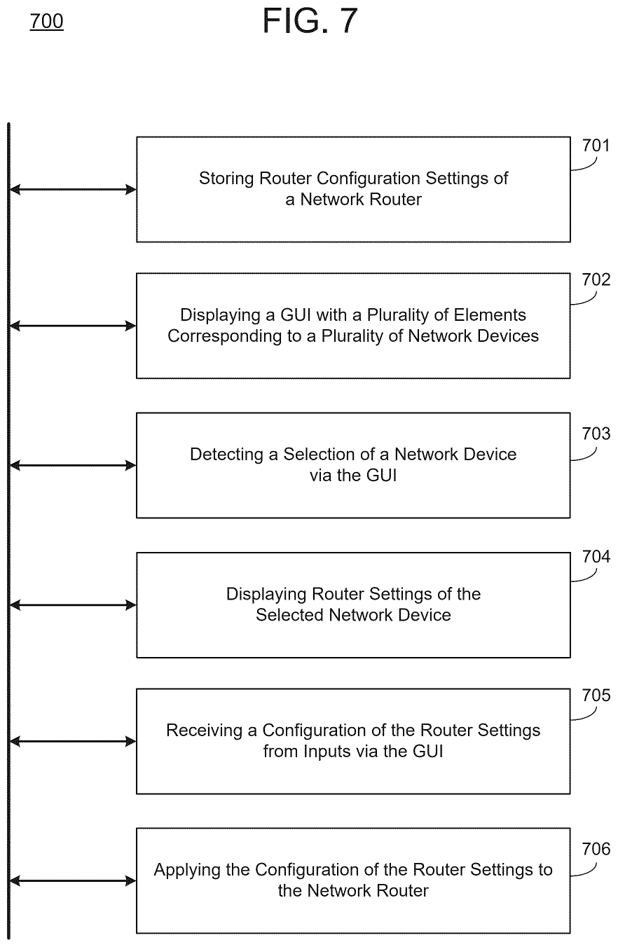

FIG. 7 illustrates a method 700 of configuring device-centric router settings through a GUI according to example embodiments. For example, the method 700 may be performed by a network router shown in any of the examples herein or the like. Referring to FIG. 7, in 701, the method may include storing router configuration settings of a network router. In 702, the method may include displaying a graphical user interface (GUI) that comprises a plurality of graphical elements corresponding to a plurality of network devices controlled by a network router. In 703, the method may include detecting a selection of a graphical element corresponding to a network device from among the plurality of graphical elements corresponding to the plurality of network devices based on a user input via the GUI. In 704, the method may include displaying router settings of the network device corresponding to the graphical element in response to the selection. In 705, the method may include receiving a configuration of the router settings of the network device based on an additional user input via the GUI. In 706, the method may include applying the configuration of the router settings of the network device to the router configuration settings of the network router.

In some embodiments, the displaying the GUI may include displaying the GUI via a software application on a computing device that is remotely connected to the network router over a computer network. In some embodiments, the receiving may include receiving a change to a configuration of one or more of Dynamic Host Configuration Protocol (DHCP) settings, Universal Plug and Play (UPnP) settings, port forward settings, category settings, country settings, hostname filters, Internet access settings, VPN usage settings, cross local area network (LAN) access settings, preferred wide area network (WAN) access settings, and notification settings. In some embodiments, the displaying the GUI may include displaying the plurality of graphical elements corresponding to the plurality of network devices on a first page of the GUI, and the displaying the router settings may include displaying the router settings of the network device corresponding to the graphical element on a second page of the GUI that is dedicated to the network device.

In some embodiments, the method may further include automatically detecting network characteristics of the network device including one or more an Internet Protocol (IP) address of the network device, a Media Access Control (MAC) address of the network device, and a network interface, and displaying the network characteristics of the network device via the GUI. In some embodiments, the receiving may include receiving one or more of an activation, an addition, a change, and removal of a router setting of the network device based on the additional user input. In some embodiments, the GUI may include a plurality of pages corresponding to the plurality of network devices, and each page corresponding to each network device comprises common router settings that can be configured via the GUI. In some embodiments, the applying may include applying the configuration of the router settings of the network device to a routing table stored by the network router.

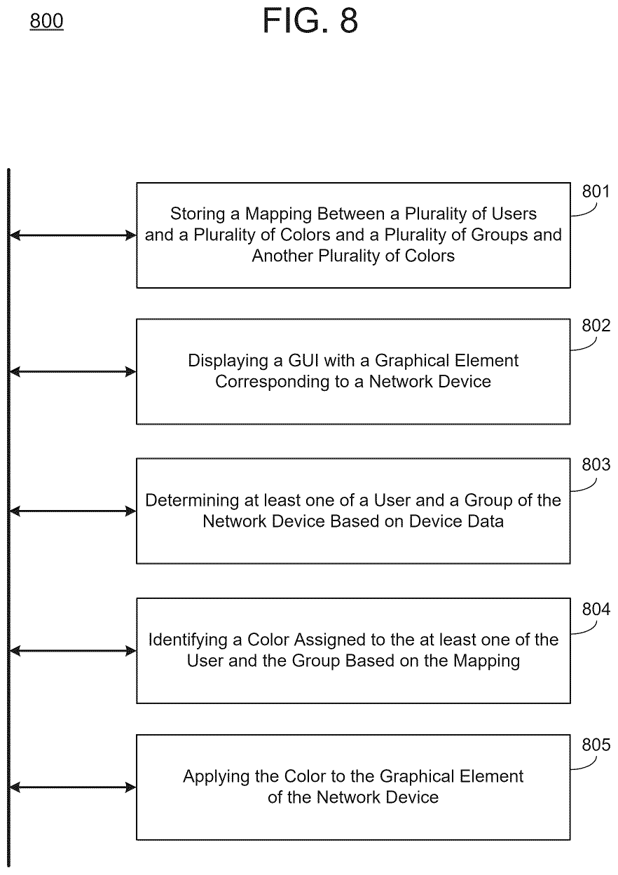

FIG. 8 illustrates a method 800 of using colors for rapid identification of a user on a network according to example embodiments. For example, the method 800 may be performed by a network router shown in any of the examples herein or the like. Referring to FIG. 8, in 801, the method may include storing a mapping between a plurality of users of a network router and a plurality of colors assigned to the plurality of users and a plurality of groups of the network router and another plurality of colors assigned to the plurality of groups, respectively. In 802, the method may include displaying a graphical user interface (GUI) that comprises a graphical element corresponding to a network device. In 803, the method may include determining at least one of a user and a group of the network device based on device data registered with the network router. In 804 the method may include identifying a color assigned to the at least one of the user and the group based on the mapping. In 805, the method may include applying the color to the graphical element corresponding to the network device displayed within the GUI.

In some embodiments, the method may further include receiving a request to open settings of the user via the GUI, and displaying a page that comprises a color palette with a plurality of colors that are capable of being assigned to the user via a settings page of the GUI. In some embodiments, the method may further include receiving a selection on the color from among the plurality of colors displayed on the settings page of the GUI, and assigning the color to the user based on selection via the settings page of the GUI. In some embodiments, the method may further include displaying a second graphical element corresponding to a second network device of the user, and applying the color to the second graphical element based on the mapping.

In some embodiments, the method may further include preventing more than one user from among the plurality of users from being assigned a same color from among the plurality of colors, at a same time. In some embodiments, the method may further include applying the color to one or more of network traffic charts, graphs, and visualizations associated with the network device of the user. In some embodiments, the method may further include applying the color to one or more of a network calendar, an alarm, and a notification associated with the network device of the user.

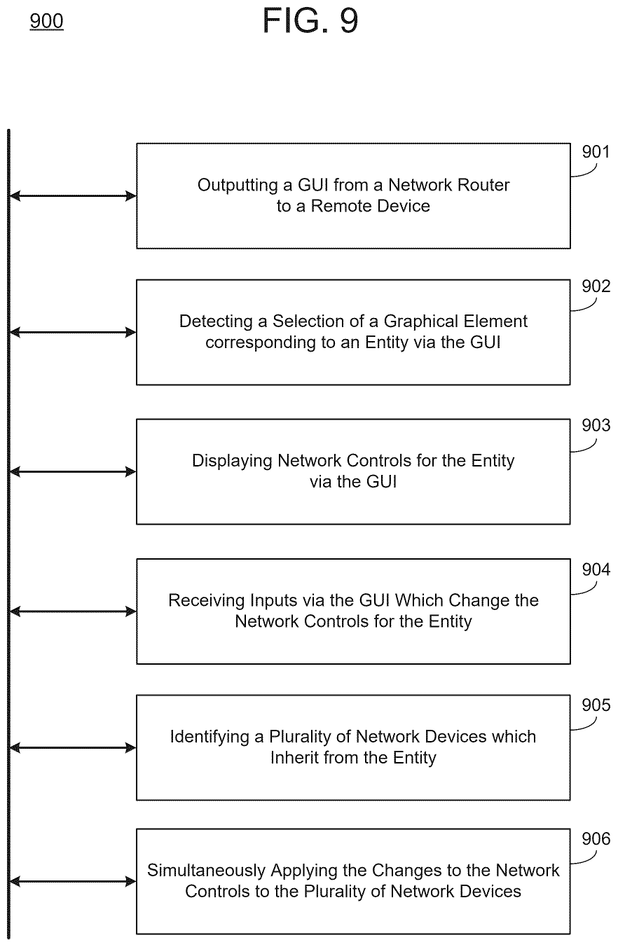

FIG. 9 illustrates a method 900 of router configuration through inheritance grouping according to example embodiments. For example, the method 900 may be performed by a network router shown in any of the examples herein or the like. Referring to FIG. 9, in 901, the method may include outputting a graphical user interface (GUI) from a network router to a software application on a remote device. In 902, the method may include detecting, via the GUI, a selection of a graphical element corresponding to an entity from among a plurality of entities of the network router. In 903, the method may include displaying a plurality of network controls for the entity via the GUI. In 904, the method may include receiving inputs via the GUI which change one or more network controls from among the plurality of network controls for the named group. In 905, the method may include identifying a plurality of network devices which inherit from the entity. In 906, the method may include simultaneously applying the change of the one or more network controls to the plurality of network devices at the network router.

In some embodiments, the simultaneously applying may include one or more of blocking network traffic to the plurality of network devices, limiting network traffic to the plurality of network devices, and redirecting network traffic from the plurality of network devices, in response to the inputs received via the GUI. In some embodiments, the displaying may include displaying a schedule associated with a network control, and receiving selections via the schedule which select one or more of a particular time and a particular day. In some embodiments, the simultaneously applying may include simultaneously applying the network control to the plurality of network devices included in the named group at the one or more of the particular time and the particular day based on the selections via the schedule.

In some embodiments, the receiving may include receiving inputs via the GUI which configure a virtual private network (VPN) connection for the named group, and the simultaneously applying comprises simultaneously applying the VPN connection to the plurality of network devices included in the named group. In some embodiments, the receiving may include receiving a pause input via the GUI which pauses Internet access for the named group, and the simultaneously applying comprises simultaneously killing an Internet connection for the plurality of network devices included in the named group in response to the pause input. In some embodiments, the method may further include determining that a network device from among the plurality of network devices is also included in a different named group with one or more different network controls that conflict with the change to the one or more network controls, and overriding the one or more different network controls based on a hierarchy among the named group and the different named group.

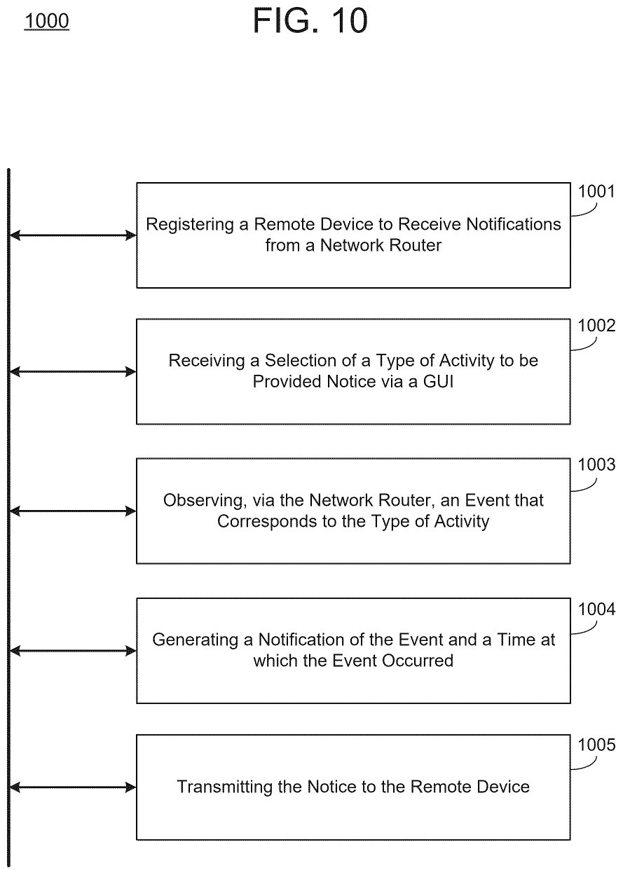

FIG. 10 illustrates a method 1000 of generating and transmitting a notification from a network router to a remote device according to example embodiments. For example, the method 1000 may be performed by a network router shown in any of the examples herein or the like. Referring to FIG. 10, in 1001, the method may include registering a remote device to receive notifications from a network router that manages access to a network based on registration data of the remote device. In 1002, the method may include receiving a selection of a type of activity which the remote device is to be provided notice of based on inputs received via a graphical user interface (GUI) output by the network router. In 1003, the method may include observing, via the network router, an event that corresponds to the type of activity. In 1004, the method may include generating a notification that includes attributes of the event observed by the network router and a time at which the event occurred. In 1005, the method may include transmitting the notification to the remote device based on the registration data of the remote device.

In some embodiments, the observing may include observing details about the event from one or more of a packet received by the network router, a system log of the network router, and a sensor of the network router, and the generating comprises including the details about the event in the notification. In some embodiments, the transmitting may include transmitting the notification to a software application installed on the remote device, wherein the notification causes the software application to display an indicator on one or more of a home screen of the remote device and a lock screen of the remote device. In some embodiments, the generating may include generating the notification to include details about one or more of a new device accessing the network and an existing device leaving the network observed by the network router, and the transmitting comprises pushing the notification to the remote device.

In some embodiments, the generating may include generating the notification to include details about a category of website accessed by a network device managed by the network router observed by the network router, and the transmitting comprises pushing the notification to the remote device. In some embodiments, the generating may include generating the notification to include details about one or more of a temperature of the network router, a memory usage of the network router, and a central processing unit (CPU) usage of the network router observed by the network router, and the transmitting comprises pushing the notification to the remote device.

In some embodiments, the generating may include generating the notification to include details about one or more of an interface being added to the network router, the interface of the network router coming online, the interface of the network router going offline, the interface exceeding a time limit, and the interface exceeding a set amount of data observed by the network router, and the transmitting comprises pushing the notification to the remote device. In some embodiments, the generating may include generating the notification to include details about one or more of a virtual private network (VPN) being added to the network router, the VPN coming online, and the VPN going offline observed by the network router, and the transmitting comprises pushing the notification to the remote device.

The above embodiments may be implemented in hardware, in a computer program executed by a processor, in firmware, or in a combination of the above. A computer program may be embodied on a non-transitory computer-readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of non-transitory storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

Although an exemplary embodiment of at least one of an apparatus, a method, and a computer-readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the capabilities of the routing apparatus shown and described with respect to various figures can be performed by one or more processors of the routing apparatus, or other components.

One skilled in the art will appreciate that a “system” could be embodied as a personal computer, a server, a console, a personal digital assistant (PDA), a cell phone, a tablet computing device, a smartphone, a smart-wearable device, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus, comprising:
a memory configured to store router configuration settings of a network router; and
a processor configured to
display a graphical user interface (GUI) that comprises a plurality of graphical elements corresponding to a plurality of network devices controlled by a network router,
detect a selection of a graphical element corresponding to a network device from among the plurality of graphical elements corresponding to the plurality of network devices based on a user input via the GUI,
display router settings of the network device corresponding to the graphical element in response to the selection,
receive a configuration of the router settings of the network device based on an additional user input via the GUI, and
apply the configuration of the router settings of the network device to the router configuration settings of the network router.

2. The apparatus of claim 1, wherein the processor is configured to display the GUI via a software application on a computing device that is remotely connected to the network router over a computer network.

3. The apparatus of claim 1, wherein the processor is configured to receive a change to a configuration of one or more of Dynamic Host Configuration Protocol (DHCP) settings, Universal Plug and Play (UPnP) settings, port forward settings, category settings, country settings, hostname filters, Internet access settings, VPN usage settings, cross local area network (LAN) access settings, preferred wide area network (WAN) access settings, and notification settings.

4. The apparatus of claim 1, wherein the processor is configured to display the plurality of graphical elements corresponding to the plurality of network devices on a first page of the GUI, and display the router settings of the network device corresponding to the graphical element on a second page of the GUI that is dedicated to the network device.

5. The apparatus of claim 1, wherein the processor is further configured to automatically detect network characteristics of the network device including one or more an Internet Protocol (IP) address of the network device, a Media Access Control (MAC) address of the network device, and a network interface, and display the network characteristics of the network device via the GUI.

6. The apparatus of claim 1, wherein the processor is configured to receive one or more of an activation, an addition, a change, and removal of a router setting of the network device based on the additional user input.

7. The apparatus of claim 1, wherein the GUI comprises a plurality of pages corresponding to the plurality of network devices, and each page corresponding to each network device comprises common router settings that can be configured via the GUI.

8. The apparatus of claim 1, wherein the processor is configured to apply the configuration of the router settings of the network device to a routing table stored by the network router.

9. A method, comprising:
storing router configuration settings of a network router;
displaying a graphical user interface (GUI) that comprises a plurality of graphical elements corresponding to a plurality of network devices controlled by a network router;
detecting a selection of a graphical element corresponding to a network device from among the plurality of graphical elements corresponding to the plurality of network devices based on a user input via the GUI;
displaying router settings of the network device corresponding to the graphical element in response to the selection;
receiving a configuration of the router settings of the network device based on an additional user input via the GUI; and
applying the configuration of the router settings of the network device to the router configuration settings of the network router.

10. The method of claim 9, wherein the displaying the GUI comprises displaying the GUI via a software application on a computing device that is remotely connected to the network router over a computer network.

11. The method of claim 9, wherein the receiving comprises receiving a change to a configuration of one or more of Dynamic Host Configuration Protocol (DHCP) settings, Universal Plug and Play (UPnP) settings, port forward settings, category settings, country settings, hostname filters, Internet access settings, VPN usage settings, cross local area network (LAN) access settings, preferred wide area network (WAN) access settings, and notification settings.

12. The method of claim 9, wherein the displaying the GUI comprises displaying the plurality of graphical elements corresponding to the plurality of network devices on a first page of the GUI, and the displaying the router settings comprises displaying the router settings of the network device corresponding to the graphical element on a second page of the GUI that is dedicated to the network device.

13. The method of claim 9, wherein the method further comprises automatically detecting network characteristics of the network device including one or more an Internet Protocol (IP) address of the network device, a Media Access Control (MAC) address of the network device, and a network interface, and displaying the network characteristics of the network device via the GUI.

14. The method of claim 9, wherein the receiving comprises receiving one or more of an activation, an addition, a change, and removal of a router setting of the network device based on the additional user input.

15. The method of claim 9, wherein the GUI comprises a plurality of pages corresponding to the plurality of network devices, and each page corresponding to each network device comprises common router settings that can be configured via the GUI.

16. The method of claim 9, wherein the applying comprises applying the configuration of the router settings of the network device to a routing table stored by the network router.

17. A computer-readable storage medium comprising instructions which when executed by a computer cause a processor to perform:
storing router configuration settings of a network router;
displaying a graphical user interface (GUI) that comprises a plurality of graphical elements corresponding to a plurality of network devices controlled by a network router;
detecting a selection of a graphical element corresponding to a network device from among the plurality of graphical elements corresponding to the plurality of network devices based on a user input via the GUI;
displaying router settings of the network device corresponding to the graphical element in response to the selection;
receiving a configuration of the router settings of the network device based on an additional user input via the GUI; and
applying the configuration of the router settings of the network device to the router configuration settings of the network router.

18. The computer-readable storage medium of claim 17, wherein the displaying the GUI comprises displaying the GUI via a software application on a computing device that is remotely connected to the network router over a computer network.

19. The computer-readable storage medium of claim 17, wherein the receiving comprises receiving a change to a configuration of one or more of Dynamic Host Configuration Protocol (DHCP) settings, Universal Plug and Play (UPnP) settings, port forward settings, category settings, country settings, hostname filters, Internet access settings, VPN usage settings, cross local area network (LAN) access settings, preferred wide area network (WAN) access settings, and notification settings.

20. The computer-readable storage medium of claim 17, wherein the displaying the GUI comprises displaying the plurality of graphical elements corresponding to the plurality of network devices on a first page of the GUI, and the displaying the router settings comprises displaying the router settings of the network device corresponding to the graphical element on a second page of the GUI that is dedicated to the network device.
